(19) United States
(12) Patent Application Publication
(10) Pub. No.: US 2022/0007654 A1
(43) Pub. Date: Jan. 13, 2022

(54) GRACILARIA BASED COMPOSITIONS FOR PLANTS AND METHODS OF APPLICATION

(71) Applicant: HELIAE DEVELOPMENT, LLC, GILBERT (AZ)

(72) Inventors: Sandip SHINDE, Gilbert, AZ (US); Manikandadas Mathilakathu MADATHIL, Mesa, AZ (US)

(21) Appl. No.: 16/319,065

(22) PCT Filed: Sep. 14, 2017
(86) PCT No.: PCT/US2017/051476

§ 371 Date: Jan. 18, 2019

Related U.S. Application Data
(60) Provisional application No. 62/395,065, filed on Sep. 15, 2016.

(51) Int. Cl. A01N 65/03; A01P 21/00; A01P 3/00

(52) U.S. Cl. CPC A01N 65/03; A01P 3/00; A01P 21/00

(57) ABSTRACT

Methods of improving characteristics of plants and soil by administering an effective amount of a Gracilaria based composition in low concentration applications are disclosed.

This patent application claims priority to U.S. Provisional Patent Application No. 62/395,065, filed Sep. 15, 2016, entitled Gracilaria Based Compositions for Plants and Methods of Application, the entirety of which is hereby incorporated by reference.

### BACKGROUND

Seed emergence occurs as an immature plant breaks out of its seed coat, typically followed by the rising of a stem out of the soil. The first leaves that appear on many seedlings are the so-called seed leaves, or cotyledons, which often bear little resemblance to the later leaves. Shortly after the first true leaves, which are more or less typical of the plant, appear, the cotyledons will drop off. Germination of seeds is a complex physiological process triggered by imbibition of water after possible dormancy mechanisms have been released by appropriate triggers. Under favorable conditions rapid expansion growth of the embryo culminates in rupture of the covering layers and emergence of the radicle. A number of agents have been proposed as modulators of seed emergence. Temperature and moisture modulation are common methods of affecting seed emergence. Addition of nutrients to the soil has also been proposed to promote emergence of seeds of certain plants.

Additionally, whether at a commercial or home garden scale, growers are constantly striving to optimize the yield and quality of a crop to ensure a high return on the investment made in every growth season. As the population increases and the demand for raw plant materials goes up for the food and renewable technologies markets, the importance of efficient agricultural production intensifies. The influence of the environment on a plant's health and production has resulted in a need for strategies during the growth season which allow the plants to compensate for the influence of the environment and maximize production. Addition of nutrients to the soil or application to the foliage has been proposed to promote yield and quality in certain plants. The effectiveness may be attributable to the ingredients or the method of preparing the product. Increasing the effectiveness of a product may reduce the amount of the product needed and increase efficiency of the agricultural process. Therefore, there is a need in the art for methods of enhancing the yield and quality of a plant.

### SUMMARY

Compositions and methods are described herein improving at least one characteristic. The compositions can include extracts from the genus Gracilaria. The composition can include Gracilaria derived products as the primary or sole active ingredient, or in combination with other active ingredients such as, but not limited to, extracts from other macroalgae, extracts from microalgae, and other microalgae cultured phototrophically, mixotrophically, or heterotrophically. The compositions can be in the form of a liquid or dry form (powder, or the like). The compositions can be stabilized through the addition of stabilizers suitable for plants, pasteurization, and combinations thereof. The methods can include applying the compositions to plants or seeds in a variety of methods, such as but not limited to, soil application, foliar application, seed treatments, and/or hydroponic application. The methods can include single or multiple applications of the compositions, and may also comprise low concentrations of Gracilaria extracts.

### DETAILED DESCRIPTION

Many plants may benefit from the application of liquid compositions that provide a bio-stimulatory effect. Non-limiting examples of plant families that can benefit from such compositions can comprise: Solanaceae, Fabaceae (Leguminosae), Poaceae, Roasaceae, Vitaceae, Brassicaeae (Cruciferae), Caricaceae, Malvaceae, Sapindaceae, Anacardiaceae, Rutaceae, Moraceae, Convolvulaceae, Lamiaceae, Verbenaceae, Pedaliaceae, Asteraceae (Compositae), Apiaceae (Umbelliferae), Araliaceae, Oleaceae, Ericaceae, Actinidaceae, Cactaceae, Chenopodiaceae, Polygonaceae, Theaceae, Lecythidaceae, Rubiaceae, Papveraceae, Illiciaceae Grossulariaceae, Myrtaceae, Juglandaceae, Bertulaceae, Cucurbitaceae, Asparagaceae (Liliaceae), Alliaceae (Liliceae), Bromeliaceae, Zingieraceae, Muscaceae, Areaceae, Dioscoreaceae, Myristicaceae, Annonaceae, Euphorbiaceae, Lauraceae, Piperaceae, and Proteaceae.

The Solanaceae plant family includes a large number of agricultural crops, medicinal plants, spices, and ornamentals in it's over 2,500 species. Taxonomically classified in the Plantae kingdom, Tracheobionta (subkingdom), Spermatophyta (superdivision), Magnoliophyta (division), Manoliopsida (class), Asteridae (subclass), and Solanales (order), the Solanaceae family includes, but is not limited to, potatoes, tomatoes, eggplants, various peppers, tobacco, and petunias. Plants in the Solanaceae can be found on all the continents, excluding Antarctica, and thus have a widespread importance in agriculture across the globe.

The Fabaceae plant family (also known as the Leguminosae) comprises the third largest plant family with over 18,000 species, including a number of important agricultural and food plants. Taxonomically classified in the Plantae kingdom, Tracheobionta (subkingdom), Spermatophyta (superdivision), Magnoliophyta (division), Manoliopsida (class), Rosidae (subclass), and Fabales (order), the Fabaceae family includes, but is not limited to, soybeans, beans, green beans, peas, chickpeas, alfalfa, peanuts, sweet peas, carob, and liquorice. Plants in the Fabaceae family can range in size and type, including but not limited to, trees, small annual herbs, shrubs, and vines, and typically develop legumes. Plants in the Fabaceae family can be found on all the continents, excluding Antarctica, and thus have a widespread importance in agriculture across the globe. Besides food, plants in the Fabaceae family can be used to produce natural gums, dyes, and ornamentals.

The Poaceae plant family supplies food, building materials, and feedstock for fuel processing. Taxonomically classified in the Plantae kingdom, Tracheobionta (subkingdom), Spermatophyta (superdivision), Magnoliophyta (division), Liliopsida (class), Commelinidae (subclass), and Cyperales (order), the Poaceae family includes, but is not limited to, flowering plants, grasses, and cereal crops such as barely, corn, lemongrass, millet, oat, rye, rice, wheat, sugarcane, and sorghum. Types of turf grass found in Arizona include, but are not limited to, hybrid Bermuda grasses (e.g., 328 tifgrn, 419 tifway, tif sport).

The Rosaceae plant family includes flowering plants, herbs, shrubs, and trees. Taxonomically classified in the Plantae kingdom, Tracheobionta (subkingdom), Spermatophyta (superdivision), Magnoliophyta (division), Magnoliopsida (class), Rosidae (subclass), and Rosales (order), the Rosaceae family includes, but is not limited to, almond, apple, apricot, blackberry, cherry, nectarine, peach, plum, raspberry, strawberry, and quince.

The Vitaceae plant family includes flowering plants and vines. Taxonomically classified in the Plantae kingdom, Tracheobionta (subkingdom), Spermatophyta (superdivision), Magnoliophyta (division), Magnoliopsida (class), Rosidae (subclass), and Rhammales (order), the Vitaceae family includes, but is not limited to, grapes.

Particularly important in the production of fruit from plants is the beginning stage of growth where the plant emerges and matures into establishment. A method of treating a seed, seedling, or plant to directly improve the germination, emergence, and maturation of the plant; or to indirectly enhance the microbial soil community surrounding the seed or seedling is therefore valuable starting the plant on the path to marketable production. The standard typically used for assessing emergence is the achievement of the hypocotyl stage, where a stem is visibly protruding from the soil. The standard typically used for assessing maturation is the achievement of the cotyledon stage, where two leaves visibly form on the emerged stem.

Also important in the production of fruit from plants is the yield and quality of fruit, which may be quantified as the number, weight, color, firmness, ripeness, moisture, degree of insect infestation, degree of disease or rot, and degree of sunburn of the fruit. A method of treating a plant to directly improve the characteristics of the plant, or to indirectly enhance the chlorophyll level of the plant for photosynthetic capabilities and health of the plant's leaves, roots, and shoot to enable robust production of fruit is therefore valuable in increasing the efficiency of marketable production. Marketable and unmarketable designations may apply to both the plant and fruit, and may be defined differently based on the end use of the product, such as but not limited to, fresh market produce and processing for inclusion as an ingredient in a composition. The marketable determination may assess such qualities as, but not limited to, color, insect damage, blossom end rot, softness, and sunburn. The term total production may incorporate both marketable and unmarketable plants and fruit. The ratio of marketable plants or fruit to unmarketable plants or fruit may be referred to as utilization and expressed as a percentage. The utilization may be used as an indicator of the efficiency of the agricultural process as it shows the successful production of marketable plants or fruit, which will be obtain the highest financial return for the grower, whereas total production will not provide such an indication.

To achieve such improvements in emergence, maturation, and yield of plants, the inventors developed a method to treat such seeds and plants, and soil with a low concentration macroalgae based composition, in a solid or liquid solution form. In some embodiments, the macroalgae comprises species of Gracilaria, such as Gracilaria gigas.

In some embodiments, the harvested Gracilaria may subjected to downstream processing and the resulting extract may be used in a dried composition (e.g., powder, pellet) or a liquid composition (e.g., suspension, solution) for application to plants, soil, or a combination thereof. Non-limiting examples of downstream processing comprise: drying the plants, lysing the plants, and subjecting the harvested plants to a solvent or supercritical carbon dioxide extraction process to isolate an oil or protein. In some embodiments, the extracted (i.e., residual) biomass remaining from an extraction process may be used alone or in combination with other biomass or extracts in a liquid composition for application to plants, soil, or a combination thereof. By subjecting the Gracilaria to an extraction process the resulting biomass is transformed from a natural whole state to a lysed condition where the cell is missing a significant amount of the natural components, thus differentiating the extracted Gracilaria biomass from that which is found in nature.

In some embodiments, Gracilaria may be the dominate active ingredient source in the composition. In some embodiments, Gracilaria comprises at least 99% of the active ingredient sources of the composition. In some embodiments, Gracilaria comprises at least 95% of the microalgae sources of the composition. In some embodiments, Gracilaria comprises at least 90% of the active ingredient sources of the composition. In some embodiments, Gracilaria comprises at least 80% of the active ingredient sources of the composition. In some embodiments, Gracilaria comprises at least 70% of the active ingredient sources of the composition. In some embodiments, Gracilaria comprises at least 60% of the active ingredient sources of the composition. In some embodiments, Gracilaria comprises at least 50% of the active ingredient sources of the composition. In some embodiments, Gracilaria comprises at least 40% of the active ingredient sources of the composition. In some embodiments, Gracilaria comprises at least 30% of the active ingredient sources of the composition. In some embodiments, Gracilaria comprises at least 20% of the active ingredient sources of the composition. In some embodiments, Gracilaria comprises at least 10% of the active ingredient sources of the composition. In some embodiments, Gracilaria comprises at least 5% of the active ingredient sources of the composition. In some embodiments, Gracilaria comprises at least 1% of the active ingredient sources of the composition. In some embodiments, the composition lacks any detectable amount of any other active ingredient species other than Gracilaria.

In some embodiments, Gracilaria extracts may also be mixed with extracts from other plants, microalgae, macroalgae, seaweeds, and kelp. Non-limiting examples of seaweeds/macroalgae that may be processed through extraction and combined with Gracilaria may comprise species of Kappaphycus, Ascophyllum, Macrocystis, Fucus, Laminaria, Sargassum, Turbinaria, and Durvilea. In further embodiments, the extracts may comprise, but are not limited to, liquid extract from a species of Kappaphycus. In some embodiments, the extracts may comprise 50% or less by volume of the composition. In some embodiments, the extracts may comprise 40% or less by volume of the composition. In some embodiments, the extracts may comprise 30% or less by volume of the composition. In some embodiments, the extracts may comprise 20% or less by volume of the composition. In some embodiments, the extracts may comprise 10% or less by volume of the composition. In some embodiments, the extracts may comprise 5% or less by volume of the composition. In some embodiments, the extracts may comprise 4% or less by volume of the composition. In some embodiments, the extracts may comprise 3% or less by volume of the composition. In some embodiments, the extracts may comprise 2% or less by volume of the composition. In some embodiments, the extracts may comprise 1% or less by volume of the composition.

In some embodiments, Gracilaria extracts may also be mixed with microalgae based biomass or extracts, such as but not limited to Chlorella, to make a composition that is beneficial when applied to plants or soil. Non-limiting examples of microalgae genus and species that can be used in the compositions and methods of the present invention include: Achnanthes orientalis, Agmenellum spp., Amphiprora hyaline, Amphora coffeiformis, Amphora coffeiformis var. linea, Amphora coffeiformis var. punctata, Amphora coffeiformis var. taylori, Amphora coffeiformis var. tenuis, Amphora delicatissima, Amphora delicatissima var. capitata, Amphora sp., Anabaena, Ankistrodesmus, Ankistrodesmus falcatus, Aurantiochytrium sp., Boekelovia hooglandii, Borodinella sp., Botryococcus braunii, Botryococcus sudeticus, Bracteococcus minor, Bracteococcus medionucleatus, Carteria, Chaetoceros gracilis, Chaetoceros muelleri, Chaetoceros muelleri var. subsalsum, Chaetoceros sp., Chlamydomonas sp., Chlamydomas perigranulata, Chlorella anitrata, Chlorella antarctica, Chlorella aureoviridis, Chlorella Candida, Chlorella capsulate, Chlorella desiccate, Chlorella ellipsoidea Chlorella emersonii, Chlorella fusca, Chlorella fusca var. vacuolate, Chlorella glucotropha, Chlorella infusionum, Chlorella infusionum var. actophila, Chlorella infusionum var. auxenophila, Chlorella kessleri, Chlorella lobophora, Chlorella luteoviridis, Chlorella luteoviridis var. aureoviridis, Chlorella luteoviridis var. lutescens, Chlorella miniata, Chlorella minutissima, Chlorella mutabilis, Chlorella nocturna, Chlorella ovalis, Chlorella parva, Chlorella photophila, Chlorella pringsheimii, Chlorella protothecoides, Chlorella protothecoides var. acidicola, Chlorella regularis, Chlorella regularis var. minima, Chlorella regularis var. umbricata, Chlorella reisiglii, Chlorella saccharophila, Chlorella saccharophila var. ellipsoidea, Chlorella salina, Chlorella simplex, Chlorella sorokiniana, Chlorella sp., Chlorella sphaerica, Chlorella stigmatophora, Chlorella vanniellii, Chlorella vulgaris, Chlorella vulgaris fo. tertia, Chlorella vulgaris var. autotrophica, Chlorella vulgaris var. viridis, Chlorella vulgaris var. vulgaris, Chlorella vulgaris var. vulgaris fo. tertia, Chlorella vulgaris var. vulgaris fo. viridis, Chlorella xanthella, Chlorella zofingiensis, Chlorella trebouxioides, Chlorella vulgaris, Chlorococcum infusionum, Chlorococcum sp., Chlorogonium, Chroomonas sp., Chrysosphaera sp., Cricosphaera sp., Crypthecodinium cohnii, Cryptomonas sp., Cyclotella cryptica, Cyclotella meneghiniana, Cyclotella sp., Dunaliella sp., Dunaliella bardawil, Dunaliella bioculata, Dunaliella granulate, Dunaliella maritime, Dunaliella minuta, Dunaliella parva, Dunaliella peircei, Dunaliella primolecta, Dunaliella salina, Dunaliella terricola, Dunaliella tertiolecta, Dunaliella viridis, Dunaliella tertiolecta, Eremosphaera viridis, Eremosphaera sp., Ellipsoidon sp., Euglena spp., Franceia sp., Fragilaria crotonensis, Fragilaria sp., Gleocapsa sp., Gloeothamnion sp., Haematococcus pluvialis, Hymenomonas sp., Isochrysis aff galbana, Isochrysis galbana, Lepocinclis, Micractinium, Monoraphidium minutum, Monoraphidium sp., Nannochloris sp., Nannochloropsis salina, Nannochloropsis sp., Navicula acceptata, Navicula biskanterae, Navicula pseudotenelloides, Navicula pelliculosa, Navicula saprophila, Navicula sp., Nephrochloris sp., Nephroselmis sp., Nitschia communis, Nitzschia alexandrina, Nitzschia closterium, Nitzschia communis, Nitzschia dissipata, Nitzschia frustulum, Nitzschia hantzschiana, Nitzschia inconspicua, Nitzschia intermedia, Nitzschia microcephala, Nitzschia pusilla, Nitzschia pusilla elliptica, Nitzschia pusilla monoensis, Nitzschia quadrangular, Nitzschia sp., Ochromonas sp., Oocystis parva, Oocystis pusilla, Oocystis sp., Oscillatoria limnetica, Oscillatoria sp., Oscillatoria subbrevis, Parachlorella kessleri, Pascheria acidophila, Pavlova sp., Phaeodactylum tricomutum, Phagus, Phormidium, Platymonas sp., Pleurochrysis camerae, Pleurochrysis dentate, Pleurochrysis sp., Porphyridium sp., Prototheca wickerhamii, Prototheca stagnora, Prototheca portoricensis, Prototheca moriformis, Prototheca zopfii, Pseudochlorella aquatica, Pyramimonas sp., Pyrobotrys, Rhodococcus opacus, Sarcinoid chrysophyte, Scenedesmus armatus, Schizochytrium, Spirogyra, Spirulina platensis, Stichococcus sp., Synechococcus sp., Synechocystisf, Tagetes erecta, Tagetes patula, Tetraedron, Tetraselmis sp., Tetraselmis suecica, Thalassiosira weissflogii, and Viridiella fridericiana.

Those of skill in the art will recognize that Chlorella and Micractinium appear closely related in many taxonomic classification trees for microalgae, and strains and species may be re-classified from time to time. Thus for references throughout the instant specification for Chlorella, it is recognized that microalgae strains in related taxonomic classifications with similar characteristics to Chlorella would reasonably be expected to produce similar results.

Additionally, taxonomic classification has also been in flux for organisms in the genus Schizochytrium. Some organisms previously classified as Schizochytrium have been reclassified as Aurantiochytrium, Thraustochytrium, or Oblongichytrium. See Yokoyama et al. Taxonomic rearrangement of the genus Schizochytrium sensu lato based on morphology, chemotaxonomic characteristics, and 18S rRNA gene phylogeny (Thrausochytriaceae, Labyrinthulomycetes): emendation for Schizochytrium and erection of Aurantiochytrium and Oblongichytrium gen. nov. Mycoscience (2007) 48:199-211. Those of skill in the art will recognize that Schizochytrium, Aurantiochytrium, Thraustochytrium, and Oblongichytrium appear closely related in many taxonomic classification trees for microalgae, and strains and species may be re-classified from time to time. Thus for references throughout the instant specification for Schizochytrium, it is recognized that microalgae strains in related taxonomic classifications with similar characteristics to Schizochytrium would reasonably be expected to produce similar results.

In one embodiment, Chlorella sp. may be cultured in mixotrophic conditions, which comprises a culture medium primary comprised of water with trace nutrients (e.g., nitrates, phosphates, vitamins, metals found in BG-11 recipe (available from UTEX The Culture Collection of Algae at the University of Texas at Austin, Austin, Tex.)), light as an energy source for photosynthesis, organic carbon (e.g., acetate, acetic acid) as both an energy source and a source of carbon. In some embodiments, the culture media may comprise BG-11 media or a media derived from BG-11 culture media (e.g., in which additional component(s) are added to the media and/or one or more elements of the media is increased by 5%, 10%, 15%, 20%, 25%, 33%, 50%, or more over unmodified BG-11 media). In some embodiments, the Chlorella may be cultured in non-axenic mixotrophic conditions in the presence of contaminating organisms, such as but not limited to bacteria. Methods of culturing such microalgae in non-axenic mixotrophic conditions may be found in WO2014/074769A2 (Ganuza, et al.), hereby incorporated by reference.

By artificially controlling aspects of the Chlorella culturing process such as the organic carbon feed (e.g., acetic acid, acetate), oxygen levels, pH, and light, the culturing process differs from the culturing process that Chlorella experiences in nature. In addition to controlling various aspects of the culturing process, intervention by human operators or automated systems occurs during the non-axenic mixotrophic culturing of Chlorella through contamination control methods to prevent the Chlorella from being overrun and outcompeted by contaminating organisms (e.g., fungi, bacteria). Contamination control methods for microalgae cultures are known in the art and such suitable contamination control methods for non-axenic mixotrophic microalgae cultures are disclosed in WO2014/074769A2 (Ganuza, et al.), hereby incorporated by reference. By intervening in the microalgae culturing process, the impact of the contaminating microorganisms can be mitigated by suppressing the proliferation of containing organism populations and the effect on the microalgal cells (e.g., lysing, infection, death, clumping). Thus through artificial control of aspects of the culturing process and intervening in the culturing process with contamination control methods, the Chlorella culture produced as a whole and used in the described inventive compositions differs from the culture that results from a Chlorella culturing process that occurs in nature.

During the mixotrophic culturing process the Chlorella culture may also comprise cell debris and compounds excreted from the Chlorella cells into the culture medium. The output of the Chlorella mixotrophic culturing process provides the active ingredient for composition that is applied to plants for improving yield and quality without separate addition to or supplementation of the composition with other active ingredients not found in the mixotrophic Chlorella whole cells and accompanying culture medium from the mixotrophic culturing process such as, but not limited to: non-Chlorella microalgae cells, microalgae extracts, macroalgae, macroalgae extracts, liquid fertilizers, granular fertilizers, mineral complexes (e.g., calcium, sodium, zinc, manganese, cobalt, silicon), fungi, bacteria, nematodes, protozoa, digestate solids, chemicals (e.g., ethanolamine, borax, boric acid), humic acid, nitrogen and nitrogen derivatives, phosphorus rock, pesticides, herbicides, insecticides, enzymes, plant fiber (e.g., coconut fiber).

In some embodiments, the mixotrophic Chlorella may be previously frozen and thawed before inclusion in the liquid composition. In some embodiments, the mixotrophic Chlorella may not have been subjected to a previous freezing or thawing process. In some embodiments, the mixotrophic Chlorella whole cells have not been subjected to a drying process. The cell walls of the mixotrophic Chlorella of the composition have not been lysed or disrupted, and the mixotrophic Chlorella cells have not been subjected to an extraction process or process that pulverizes the cells. The mixotrophic Chlorella whole cells are not subjected to a purification process for isolating the mixotrophic Chlorella whole cells from the accompanying constituents of the culturing process (e.g., trace nutrients, residual organic carbon, bacteria, cell debris, cell excretions), and thus the whole output from the mixotrophic Chlorella culturing process comprising whole Chlorella cells, culture medium, cell excretions, cell debris, bacteria, residual organic carbon, and trace nutrients, is used in the liquid composition for application to plants. In some embodiments, the mixotrophic Chlorella whole cells and the accompanying constituents of the culturing process are concentrated in the composition. In some embodiments, the mixotrophic Chlorella whole cells and the accompanying constituents of the culturing process are diluted in the composition to a low concentration. The mixotrophic Chlorella whole cells of the composition are not fossilized. In some embodiments, the mixotrophic Chlorella whole cells are not maintained in a viable state in the composition for continued growth after the method of using the composition in a soil or foliar application. In some embodiments, the mixotrophic Chlorella base composition may be biologically inactive after the composition is prepared. In some embodiments, the mixotrophic Chlorella base composition may be substantially biologically inactive after the composition is prepared. In some embodiments, the mixotrophic Chlorella base composition may increase in biological activity after the prepared composition is exposed to air.

In some embodiments, a liquid composition may comprise low concentrations of bacteria contributing to the solids percentage of the composition in addition to the whole mixotrophic Chlorella cells. Examples of bacteria found in non-axenic mixotrophic conditions may be found in WO2014/074769A2 (Ganuza, et al.), hereby incorporated by reference. A live bacteria count may be determined using methods known in the art such as plate counts, plates counts using Petrifilm available from 3M (St. Paul, Minn.), spectrophotometric (turbidimetric) measurements, visual comparison of turbidity with a known standard, direct cell counts under a microscope, cell mass determination, and measurement of cellular activity. Live bacteria counts in a non-axenic mixotrophic microalgae culture may range from 10⁴ to 10⁹ CFU/mL, and may depend on contamination control measures taken during the culturing of the microalgae. The level of bacteria in the composition may be determined by an aerobic plate count which quantifies aerobic colony forming units (CFU) in a designated volume. In some embodiments, the composition comprises an aerobic plate count of 40,000-400,000 CFU/mL. In some embodiments, the composition comprises an aerobic plate count of 40,000-100,000 CFU/mL. In some embodiments, the composition comprises an aerobic plate count of 100,000-200,000 CFU/mL. In some embodiments, the composition comprises an aerobic plate count of 200,000-300,000 CFU/mL. In some embodiments, the composition comprises an aerobic plate count of 300,000-400,000 CFU/mL.

In some embodiments, the macroalgae based composition can be supplemented with a supplemental nutrient such as nitrogen, phosphorus, or potassium to increase the levels within the composition to at least 1% of the total composition (i.e., addition of N, P, or K to increase levels at least 1-0-0, 0-1-0, 0-0-1, or combinations thereof). In some embodiments, the macroalgae composition may be supplemented with nutrients such as, but not limited to, calcium, magnesium, silicon, sulfur, iron, manganese, zinc, copper, boron, molybdenum, chlorine, sodium, aluminum, vanadium, nickel, cerium, dysprosium, erbium, europium, gadolinium, holmium, lanthanum, lutetium, neodymium, praseodymium, promethium, samarium, scandium, terbium, thulium, ytterbium, and yttrium. In some embodiments, the supplemented nutrient is not uptaken, chelated, or absorbed by the microalgae. In some embodiments, the concentration of the supplemental nutrient may comprise 1-50 g per 100 g of the composition.

A liquid composition comprising macroalgae extracts may be stabilized by heating and cooling in a pasteurization process. As shown in the Examples, the inventors found that the active ingredients of the Gracilaria based composition maintained effectiveness in at least one characteristic of a plant after being subjected to the heating and cooling of a pasteurization process. In other embodiments, liquid compositions with biomass or extracts of Gracilaria may not need to be stabilized by pasteurization. For example, Gracilaria biomass that have been processed, such as by drying, lysing, and extraction, or extracts may comprise such low levels of bacteria that a liquid composition may remain stable without being subjected to the heating and cooling of a pasteurization process.

In some embodiments, the composition may be heated to a temperature in the range of 50-70° C. In some embodiments, the composition may be heated to a temperature in the range of 55-65° C. In some embodiments, the composition may be heated to a temperature in the range of 58-62° C. In some embodiments, the composition may be heated to a temperature in the range of 50-60° C. In some embodiments, the composition may be heated to a temperature in the range of 60-70° C.

In some embodiments, the composition may be heated for a time period in the range of 90-150 minutes. In some embodiments, the composition may be heated for a time period in the range of 110-130 minutes. In some embodiments, the composition may be heated for a time period in the range of 90-100 minutes. In some embodiments, the composition may be heated for a time period in the range of 100-110 minutes. In some embodiments, the composition may be heated for a time period in the range of 110-120 minutes. In some embodiments, the composition may be heated for a time period in the range of 120-130 minutes. In some embodiments, the composition may be heated for a time period in the range of 130-140 minutes. In some embodiments, the composition may be heated for a time period in the range of 140-150 minutes.

After the step of heating or subjecting the liquid composition to high temperatures is complete, the compositions may be cooled at any rate to a temperature that is safe to work with. In one non-limiting embodiment, the composition may be cooled to a temperature in the range of 35-45° C. In some embodiments, the composition may be cooled to a temperature in the range of 36-44° C. In some embodiments, the composition may be cooled to a temperature in the range of 37-43° C. In some embodiments, the composition may be cooled to a temperature in the range of 38-42° C. In some embodiments, the composition may be cooled to a temperature in the range of 39-41° C. In further embodiments, the pasteurization process may be part of a continuous production process that also involves packaging, and thus the liquid composition may be packaged (e.g., bottled) directly after the heating or high temperature stage without a cooling step.

In some embodiments, the composition may comprise 5-30% by weight of macroalgae extracts (i.e., 5-30 g of macroalgae extracts/100 mL of the liquid composition). In some embodiments, the composition may comprise 5-20% by weight of macroalgae extracts. In some embodiments, the composition may comprise 5-15% by weight of macroalgae extracts. In some embodiments, the composition may comprise 5-10% by weight of macroalgae extracts. In some embodiments, the composition may comprise 10-20% by weight of macroalgae extracts. In some embodiments, the composition may comprise 10-20% by weight of macroalgae extracts. In some embodiments, the composition may comprise 20-30% by weight of macroalgae extracts. In some embodiments, further dilution of the macroalgae extracts by weight may be occur before application for low concentration applications of the composition.

In some embodiments, the composition may comprise less than 1% by weight of macroalgae extracts (i.e., less than 1 g of macroalgae derived product/100 mL of the liquid composition). In some embodiments, the composition may comprise less than 0.9% by weight of macroalgae extracts. In some embodiments, the composition may comprise less than 0.8% by weight of macroalgae extracts. In some embodiments, the composition may comprise less than 0.7% by weight of macroalgae extracts. In some embodiments, the composition may comprise less than 0.6% by weight of macroalgae extracts. In some embodiments, the composition may comprise less than 0.5% by weight of macroalgae extracts. In some embodiments, the composition may comprise less than 0.4% by weight of macroalgae extracts. In some embodiments, the composition may comprise less than 0.3% by weight of macroalgae extracts. In some embodiments, the composition may comprise less than 0.2% by weight of macroalgae extracts. In some embodiments, the composition may comprise less than 0.1% by weight of macroalgae extracts. In some embodiments, the composition may comprise at least 0.0001% by weight of macroalgae extracts. In some embodiments, the composition may comprise at least 0.001% by weight of macroalgae extracts. In some embodiments, the composition may comprise at least 0.01% by weight of macroalgae extracts. In some embodiments, the composition may comprise 0.00001-1% by weight of macroalgae extracts. In some embodiments, the composition may comprise 0.0001-0.001% by weight of macroalgae extracts. In some embodiments, the composition may comprise 0.001-0.01% by weight of macroalgae extracts. In some embodiments, the composition may comprise 0.01-0.1% by weight of macroalgae extracts. In some embodiments, the composition may comprise 0.1-1% by weight of macroalgae extracts.

In some embodiments, an application concentration of 0.1% of macroalgae extracts equates to 0.04 g of macroalgae extracts in 40 mL of a composition. While the desired application concentration to a plant may be 0.1% of macroalgae extracts, the composition may be packaged as a 10% concentration (0.4 mL in 40 mL of a composition). Thus a desired application concentration of 0.1% would require 6,000 mL of the 10% macroalgae extracts in the 100 gallons of water applied to the assumption of 15,000 plants in an acre, which is equivalent to an application rate of about 1.585 gallons per acre. In some embodiments, a desired application concentration of 0.01% of macroalgae extracts using a 10% concentration composition equates to an application rate of about 0.159 gallons per acre. In some embodiments, a desired application concentration of 0.001% of macroalgae extracts using a 10% concentration composition equates to an application rate of about 0.016 gallons per acre. In some embodiments, a desired application concentration of 0.0001% of macroalgae extracts using a 10% concentration composition equates to an application rate of about 0.002 gallons per acre.

In another non-limiting embodiment, correlating the application of the macroalgae extracts on a per plant basis using the assumption of 15,000 plants per acre, the composition application rate of 1 gallon per acre is equal to about 0.25 mL per plant=0.025 g per plant=25 mg of macroalgae extracts per plant. The water requirement assumption of 100 gallons per acre is equal to about 35 mL of water per plant. Therefore, 0.025 g of macroalgae extracts in 35 mL of water is equal to about 0.071 g of macroalgae extracts per 100 mL of composition equates to about a 0.07% application concentration. In some embodiments, the macroalgae extracts based composition may be applied at a rate in a range as low as about 0.001-10 gallons per acre, or as high as up to 150 gallons per acre.

In some embodiments, stabilizing means that are not active regarding the improvement of plant germination, emergence, maturation, quality, and yield, but instead aid in stabilizing the composition may be added to prevent the proliferation of unwanted microorganisms (e.g., yeast, mold) and prolong shelf life. Such inactive but stabilizing means may comprise an acid, such as but not limited to phosphoric acid or citric acid, and a yeast and mold inhibitor, such as but not limited to potassium sorbate. In some embodiments, the stabilizing means are suitable for plants and do not inhibit the growth or health of the plant. In the alternative, the stabilizing means may contribute to nutritional properties of the liquid composition, such as but not limited to, the levels of nitrogen, phosphorus, or potassium.

In some embodiments, the composition may comprise less than 0.3% phosphoric acid. In some embodiments, the composition may comprise 0.01-0.3% phosphoric acid. In some embodiments, the composition may comprise 0.05-0.25% phosphoric acid. In some embodiments, the composition may comprise 0.01-0.1% phosphoric acid. In some embodiments, the composition may comprise 0.1-0.2% phosphoric acid. In some embodiments, the composition may comprise 0.2-0.3% phosphoric acid. In some embodiments, the composition may comprise less than 0.3% citric acid. In some embodiments, the composition may comprise 0.01-0.3% citric acid. In some embodiments, the composition may comprise 0.05-0.25% citric acid. In some embodiments, the composition may comprise 0.01-0.1% citric acid. In some embodiments, the composition may comprise 0.1-0.2% citric acid. In some embodiments, the composition may comprise 0.2-0.3% citric acid.

In some embodiments, the composition may comprise less than 0.5% potassium sorbate. In some embodiments, the composition may comprise 0.01-0.5% potassium sorbate. In some embodiments, the composition may comprise 0.05-0.4% potassium sorbate. In some embodiments, the composition may comprise 0.01-0.1% potassium sorbate. In some embodiments, the composition may comprise 0.1-0.2% potassium sorbate. In some embodiments, the composition may comprise 0.2-0.3% potassium sorbate. In some embodiments, the composition may comprise 0.3-0.4% potassium sorbate. In some embodiments, the composition may comprise 0.4-0.5% potassium sorbate.

In some embodiments, the composition is a liquid and substantially comprises of water. In some embodiments, the composition may comprise 70-99% water. In some embodiments, the composition may comprise 85-95% water. In some embodiments, the composition may comprise 70-75% water. In some embodiments, the composition may comprise 75-80% water. In some embodiments, the composition may comprise 80-85% water. In some embodiments, the composition may comprise 85-90% water. In some embodiments, the composition may comprise 90-95% water. In some embodiments, the composition may comprise 95-99% water. The liquid nature and high water content of the composition facilitates administration of the composition in a variety of manners, such as but not limit to: flowing through an irrigation system, flowing through an above ground drip irrigation system, flowing through a buried drip irrigation system, flowing through a central pivot irrigation system, sprayers, sprinklers, and water cans.

In some embodiments, the liquid composition may be used immediately after formulation, or may be stored in containers for later use. In some embodiments, the composition may be stored out of direct sunlight. In some embodiments, the composition may be refrigerated. In some embodiments, the composition may be stored at 1-10° C. In some embodiments, the composition may be stored at 1-3° C. In some embodiments, the composition may be stored at 3-5° C. In some embodiments, the composition may be stored at 5-8° C. In some embodiments, the composition may be stored at 8-10° C.

In some embodiments, administration of the liquid composition to a seed or plant may be in an amount effective to produce an enhanced characteristic in plants compared to a substantially identical population of untreated seeds or plants. Such enhanced characteristics may comprise accelerated seed germination, accelerated seedling emergence, improved seedling emergence, improved leaf formation, accelerated leaf formation, improved plant maturation, accelerated plant maturation, increased plant yield, increased plant growth, increased plant quality, increased plant health, increased fruit yield, increased fruit growth, and increased fruit quality. Non-limiting examples of such enhanced characteristics may comprise accelerated achievement of the hypocotyl stage, accelerated protrusion of a stem from the soil, accelerated achievement of the cotyledon stage, accelerated leaf formation, increased marketable plant weight, increased marketable plant yield, increased marketable fruit weight, increased production plant weight, increased production fruit weight, increased utilization (indicator of efficiency in the agricultural process based on ratio of marketable fruit to unmarketable fruit), increased chlorophyll content (indicator of plant health), increased plant weight (indicator of plant health), increased root weight (indicator of plant health), increased shoot weight (indicator of plant health), increased plant height, increased thatch height, increased resistance to salt stress, increased plant resistance to heat stress (temperature stress), increased plant resistance to heavy metal stress, increased plant resistance to drought, increased plant resistance to disease, improved color, reduced insect damage, reduced blossom end rot, and reduced sun burn. Such enhanced characteristics may occur individually in a plant, or in combinations of multiple enhanced characteristics.

In some embodiments, the macroalgae extracts may be combined with microalgae biomass may be dried or dehydrated to form a composition of macroalgae extracts and dried microalgae biomass (i.e., reduced moisture content). The microalgae biomass may be dried by at least one method selected from the group consisting of: freeze drying (or lypohilization), drum (or rotary) drying, spray drying, crossflow air drying, solar drying, vacuum shelf drying, pulse combustion drying, flash drying, furnace drying, belt conveyor drying, and refractance window drying. In some embodiments, the microalgae cells may be dried by a combination of two or more methods, such as in a process with multiple drying methods in series. The process of drying the biomass may reduce the percent moisture (on a wet basis) to the range of about 1-15% and result in a cake, flakes, or a powder, which is more uniform and more stable than the wet culture of macroalgae. In some embodiments, the dried microalgae may be intact. In some embodiments, the dried microalgae may be lysed or disrupted. In some embodiments, the microalgae may be lysed or disrupted prior to or after drying by mechanical, electrical, acoustic, or chemical means. In some embodiments, drying the microalgae achieves an acceptable product stability for storage, with the reduction or elimination of chemical stabilizers. The composition may be stored in any suitable container such as, but not limited to, a bag, bucket, jug, tote, or bottle.

In some embodiments, the dried microalgae biomass may have a moisture content of 1-15% on a wet basis. In some embodiments, the dried microalgae biomass may have a moisture content of 1-2% on a wet basis. In some embodiments, the dried microalgae biomass may have a moisture content of 2-3% on a wet basis. In some embodiments, the dried microalgae biomass may have a moisture content of 3-5% on a wet basis. In some embodiments, the dried microalgae biomass may have a moisture content of 5-7% on a wet basis. In some embodiments, the dried microalgae biomass may have a moisture content of 7-10% on a wet basis. In some embodiments, the dried microalgae biomass may have a moisture content of 10-12% on a wet basis. In some embodiments, the dried microalgae biomass may have a moisture content of 12-15% on a wet basis. In some embodiments, the dried microalgae biomass may have a moisture content of 1-8% on a wet basis. In some embodiments, the dried microalgae biomass may have a moisture content of 8-15% on a wet basis.

The various drying processes may have different capabilities such as, but not limited to, the amount of moisture that may be removed, the preservation of metabolites (e.g., proteins, lipids, pigments, carbohydrates, polysaccharides, soluble nitrogen, phytohormones), and the effect on the cell wall or membrane. For example, loss of protein in Spirulina biomass has been found to increase proportionally as the drying temperature increases. Additionally, drying at high temperatures has been shown to alter polymer chains, alter interactions between polysaccharide and glycoprotein, and increase bound water content of polysaccharides. Pigments and fatty acids are also known to oxidize and de-stabilize to different degrees in different drying processes. The effectiveness of each drying method may also vary based on the microalgae species due to different physical characteristics of the microalgae (e.g., sheer sensitivity, cell size, cell wall thickness and composition). The method of drying and drying method parameters may also result in a structural change to the microalgae cell such as, but not limited to, increased porosity in the cell wall, changes in the cell wall make up or bonds, and measurable changes in cell characteristics (e.g., elasticity, viscosity, digestibility); as wells as functional differences when applied to plants that can be measured in changes in plant performance or plant characteristics. Drying microalgae with a combination of methods in series may also result in structural and functional changes, minimize structural and functional changes, or increase the effectiveness for a particular type of microalgae.

Drum drying comprises the use of sloped, rotating cylinders which use gravity to move the microalgal biomass from one end to the other. Drum drying may be conducted with direct contact between a hot gas and the microalgal biomass, or indirect heating in which the gas and microalgal biomass is separated by a barrier such as a steel shell. A non-limiting example of a drum drying process for Scenedesmus may comprise 10 seconds of heating at 120° C. Possible effects to the microalga biomass in a drum drying process include sterilization of the biomass, and breaking of the cell wall. Microalgal biomass that is drum dried may have higher digestibility than microalgal biomass that is spray dried.

Freeze drying comprises freezing the microalgal biomass and then transferring the frozen biomass to a vacuum chamber with reduced pressure (e.g., 4.6 Torr). The ice in the microalgal biomass changes to vapor through sublimation which is collected on an extremely cold condenser and removed from the vacuum chamber. Freeze drying typically minimizes the degradation of unsaturated fatty acids and pigments (e.g., carotenoids) through oxidation, which preserves the nutritional value of the microalgal biomass. Although the targeted removal of water in the freeze drying process is beneficial, the process is very costly and time consuming which makes freeze drying impractical for many commercial applications. In some embodiments, microalgae dried by freeze drying may comprise 2-6% moisture (on a wet basis). A non-limiting example of a freeze drying process for Scenedesmus may comprise 24 hours at −84° C. Freeze drying is known to maintain the integrity of the microalgal cell, but is also known been known in some cases to disrupt the cell or increase the pore size in the cell wall. In Scenedesmus, freeze drying was found to decrease rigidity, increase surface area by 165%, and increase pore size by 19% of the cells (see eSEM images below). In Phaeodactylum ricornutum, freeze drying had no effect on the total lipid content, made the cells more susceptible to lipolysis (i.e., breakdown of lipids, hydrolysis of triglycerides into glycerol and free fatty acids) upon storage than spray dried cells, and made the cells less susceptible to oxidation than spray dried cells.

Spray drying comprises atomizing an aqueous microalgae culture into droplets sprayed downwardly in a vertical tower through which hot gases pass downward. The gas stream may be exhausted through a cyclonic separator. The process of spray drying is expensive, but slightly cheaper than freeze drying. Spray drying has become the method of choice for high value products (>$1,000/ton). With the proper type of burner, oxygen can be virtually eliminated from the recycled drying gas, which prevents the oxidation of oxygen sensitive products (e.g., carotenoids). In some embodiments, microalgae dried by spray drying may comprise 1-7% moisture (on a wet basis). Examples of spray drying systems include: box dryers, tall-form spray dryers, fluidized bed dryers, and moving fluidized bed dryers (e.g., FilterMat spray dryer GEA Process Engineering Inc.). An open cycle spray dryer with a particular direct fired air heater may operate at elevated temperatures (e.g., 60-93° C.) and high oxygen concentrations (e.g., 19-20%). The possible effects of spray drying on microalgal biomass include rupturing the cells walls, reduction of protein content by 10-15%, significant deterioration of pigments (depending on the oxygen concentration), and a lower digestibility than drum drying. In Phyaeodactylum ricornutum, spray drying had no effect on the total lipid content, made the cells less susceptible to lipolysis than freeze drying, and made the cells more susceptible to oxidation than freeze drying (possibly due to the breakdown of protective carotenoids).

Crossflow air drying uses movement of heated air across a layer of microalgae on a tray, which is a modification of indirect solar and convection oven driers. Crossflow air drying is faster than solar drying, cheaper than drum drying, and is known to typically not break the microalgal cell wall. In some embodiments, microalgae dried by crossflow air drying may comprise 8-12% moisture (on a wet basis). Non-limiting examples of crossflow air drying for Spirulina may comprise: 1) a temperature of 62° C. for 14 hours, 2) a temperature of 50-60° C., a relative humidity of 7-10%, an air velocity of 1.5 m/s, and a duration of 150-220 minutes, 3) a temperature of 40-60° C. and an air velocity of 1.9-3.8 m/s, and 4) temperatures of 50-70° C. for layers of 3-7 mm in a perforated tray with parallel air flow. Crossflow air drying of Spirulina has shown a loss in protein of about 17% and a loss in phycocyanin of 37-50%. Particularly, degradation of phycocyanin was found to occur above 60° C., but there was no significant change in the fatty acid composition in the crossflow air drying methods.

Non-limiting examples of crossflow air drying of Chlorella kessleri and Chlamydomonas reinhardtii may comprise a temperature of 55° C. for more than 5 hours. Crossflow air drying of Chlorella kessleri and Chlamydomonas reinhardtii has produced a reduction of chlorophyll relative to the dry cell weight, an increase of total fatty acid content relative to the dry cell, a decrease of polar lipids relative to the dry cell weight, and a decrease in the availability of nutritional salts (e.g., S, N). A cell's sensitivity to air drying stress (as measured through the change in chlorophyll) may be correlated to the properties of the cell wall. For example, the crossflow air dried Chlamydomonas reinhardtii (hydroxyproline-rich glucoprotein based cell walls) had a larger decrease in chlorophyll than the Chlorella kessleri (sugar based cell walls), which may be associated with the cell wall's ability to restructure in S and N deficient conditions. In a non-limiting example of drying 5-7 mm thick layers of Aphanothece microscopia Nageli at temperatures of 40-60° C. with parallel air flow of 1.5 m/s, it was found that drying conditions influenced the concentrations of protein, carbohydrates, and lipids in the biomass.

Solar drying methods may comprise the use of direct solar radiation to dry microalgae on sand or a plastic sheet, or the indirect use of solar radiation to heat air that is circulated around microalgae in a dryer. Direct solar drying is strongly weather dependent, slow, and may require a short duration of high heat (e.g., 120° C.) to increase the biological value of the microalgal biomass. A non-limiting example of a direct solar drying process for Scenedesmus may comprise a 1,500 micron thickness white plastic drying bed liner, a temperature of 25-30° C., and a duration of 72 hours. The possible effects of direct solar drying on microalgal biomass include chlorophyll degradation, overheating of the biomass, and creation of an unpleasant odor. Indirect solar drying prevents overheating, has a higher drying rate than direct solar drying, but produces a less attractive profile in the final product. An indirect solar drying method for microalgae may comprise temperature of 65-70° C. for 0.5-6 hours.

Drying of a thin film of microalgal biomass in a convection oven is a fairly common practice performed in scientific literature to test the biomass going through further processing, but may be less practical for many commercial applications. Thin film convection oven drying has been demonstrated in the literature with species of Chlorella, Chlamydomonas, and Scenedesmus. In some embodiments, microalgae dried by oven drying may comprise 6-10% moisture (on a wet basis). Thin film convection oven drying methods may comprise temperatures of 30-90° C., and durations of 4-12 hours. Thin film convection oven dried microalgal biomass showed no significant change in the fatty acid profile and a slight decrease in the degree of unsaturation of fatty acids at higher temperature for ruptured cells (likely due to oxidation causing cleavage of unsaturated bonds).

Microalgae may be dried in thin layers with heat at a reduced pressure. Non-limiting examples of drying of Spirulina in layers within a vacuum may comprise temperatures of 50-65° C. and a pressure of 0.05-0.06 atm. Possible effects on the microalgae that may result from vacuum shelf drying include development of a hygroscopic property (i.e., ability to attract and hold water particles from the surrounding environment by absorption or adsorption) and development of a porous structure.

Pulse combustion drying uses a blast of controlled heat to flash dry the microalgae. Air is pumped into a combustion chamber, mixed with a fuel and ignited to created pressurized hot gas (e.g., at 3 psi). The dryer may automatically blast the heated gas with quench air to control the temperature of the heated gas before coming into contact with the microalgae. The process is then repeated multiple times to provide the pulses of heated gas. Pulse combustion heating is known to dry microalgae at a low heat which preserves the integrity and nutritional value of the microalgae. Flash drying comprises spraying or injecting a mixture of dried and undried material into a hot gas stream, and is commonly used in wastewater sludge drying.

Drying of microalgae using an incinerator or furnace may comprise heating the biomass to a high temperature (e.g., 100° C.) to evaporate the water. The heating may be performed at a level below the temperature at which the microalgae will burn and may comprise using hot gases that proceed downwardly with the biomass in parallel flow. Microalgae that are dewatered to an appropriate solids level may be dried indirectly by heating elements lining the pathway of a belt conveyor. Refractance window drying is a dehydration method that uses infra-red light, rather than high direct temperature, to remove moisture from microalgae. Wet microalgae biomass may be translated through an evaporation chamber by a belt disposed above a circulating hot water reservoir to dry the microalgae with infra-red energy in a refractance window drying. In some embodiments, microalgae dried by refractance window drying may comprise 3-8% moisture (on a wet basis).

In some embodiments, the dry composition may be mixed with water and stabilized by heating and cooling in a pasteurization process, adjustment of pH, the addition of an inhibitor of yeast and mold growth, or combinations thereof. In one non-limiting example of preparing the dried microalgae composition for application to plants, the microalgae harvested from the culturing system is first held in a harvest tank before centrifuging the culture. Once the microalgae is centrifuged, the centrifuge discharges the fraction rich in microalgae whole cell solids, but also containing the accompanying constituents from the culture medium, into a container at a temperature of about 30° C. The microalgae composition is then dried.

Surprisingly, the inventors found that administration of the described composition in low concentration applications was effective in producing enhanced characteristics in plants. In some embodiments, a liquid composition may be administered before the seed is planted. In some embodiments, a liquid composition may be administered at the time the seed is planted. In some embodiments, a liquid composition may be administered after the seed is planted. In some embodiments, a liquid composition may be administered to plants that have emerged from the ground. In some embodiments, a dried composition may be applied to the soil before, during, or after the planting of a seed. In some embodiments, a dried composition may be applied to the soil before or after a plant emerges from the soil.

In some embodiments, the volume or mass of the microalgae based composition applied to a seed, seedling, or plant may not increase or decrease during the growth cycle of the plant (i.e., the amount of the microalgae composition applied to the plant will not change as the plant grows larger). In some embodiments, the volume or mass of the microalgae based composition applied to a seed, seedling, or plant may increase during the growth cycle of the plant (i.e., applied on a mass or volume per plant mass basis to provide more of the microalgae composition as the plant grows larger). In some embodiments, the volume or mass of the microalgae based composition applied to a seed, seedling, or plant may decrease during the growth cycle of the plant (i.e., applied on a mass or volume per plant mass basis to provide more of the microalgae composition as the plant grows larger).

Seed Soak Application

In one non-limiting embodiment, the administration of the liquid composition may comprise soaking the seed in an effective amount of the liquid composition before planting the seed. In some embodiments, the administration of the liquid composition further comprises removing the seed from the liquid composition after soaking, and drying the seed before planting. In some embodiments, the seed may be soaked in the liquid composition for a time period in the range of 90-150 minutes. In some embodiments, the seed may be soaked in the liquid composition for a time period in the range of 110-130 minutes. In some embodiments, the seed may be soaked in the liquid composition for a time period in the range of 90-100 minutes. In some embodiments, the seed may be soaked in the liquid composition for a time period in the range of 100-110 minutes. In some embodiments, the seed may be soaked in the liquid composition for a time period in the range of 110-120 minutes. In some embodiments, the seed may be soaked in the liquid composition for a time period in the range of 120-130 minutes. In some embodiments, the seed may be soaked in the liquid composition for a time period in the range of 130-140 minutes. In some embodiments, the seed may be soaked in the liquid composition for a time period in the range of 140-150 minutes.

The composition may be diluted to a lower concentration for an effective amount in a seed soak application by mixing a volume of the composition in a volume of water. The concentration of macroalgae sourced components resulting in the diluted composition may be calculated by the multiplying the original concentration in the composition by the ratio of the volume of the composition to the volume of water. Alternatively, the grams of macroalgae sourced components in the diluted composition can be calculated by the multiplying the original grams of macroalgae sourced components per 100 mL by the ratio of the volume of the composition to the volume of water.

Soil Application—Seed

In another non-limiting embodiment, the administration of the composition may comprise contacting the soil in the immediate vicinity of the planted seed with an effective amount of the composition. In some embodiments, the liquid composition may be supplied to the soil by injection into a low volume irrigation system, such as but not limited to a drip irrigation system supplying water beneath the soil through perforated conduits or at the soil level by fluid conduits hanging above the ground or protruding from the ground. In some embodiments, the liquid composition may be supplied to the soil by a soil drench method wherein the liquid composition is poured on the soil.

The composition may be diluted to a lower concentration for an effective amount in a soil application by mixing a volume of the composition in a volume of water. The concentration of macroalgae sourced components resulting in the diluted composition may be calculated by the multiplying the original concentration in the composition by the ratio of the volume of the composition to the volume of water. Alternatively, the grams of macroalgae sourced components in the diluted composition can be calculated by the multiplying the original grams of macroalgae sourced components per 100 mL by the ratio of the volume of the composition to the volume of water.

The rate of application of the composition at the desired concentration may be expressed as a volume per area. In some embodiments, the rate of application of the liquid composition in a soil application may comprise a rate in the range of 50-150 gallons/acre. In some embodiments, the rate of application of the liquid composition in a soil application may comprise a rate in the range of 75-125 gallons/acre. In some embodiments, the rate of application of the liquid composition in a soil application may comprise a rate in the range of 50-75 gallons/acre. In some embodiments, the rate of application of the liquid composition in a soil application may comprise a rate in the range of 75-100 gallons/acre. In some embodiments, the rate of application of the liquid composition in a soil application may comprise a rate in the range of 100-125 gallons/acre. In some embodiments, the rate of application of the liquid composition in a soil application may comprise a rate in the range of 125-150 gallons/acre.

In some embodiments, the rate of application of the liquid composition in a soil application may comprise a rate in the range of 10-50 gallons/acre. In some embodiments, the rate of application of the liquid composition in a soil application may comprise a rate in the range of 10-20 gallons/acre. In some embodiments, the rate of application of the liquid composition in a soil application may comprise a rate in the range of 20-30 gallons/acre. In some embodiments, the rate of application of the liquid composition in a soil application may comprise a rate in the range of 30-40 gallons/acre. In some embodiments, the rate of application of the liquid composition in a soil application may comprise a rate in the range of 40-50 gallons/acre.

In some embodiments, the rate of application of the liquid composition in a soil application may comprise a rate in the range of 0.01-10 gallons/acre. In some embodiments, the rate of application of the liquid composition in a soil application may comprise a rate in the range of 0.01-0.1 gallons/acre. In some embodiments, the rate of application of the liquid composition in a soil application may comprise a rate in the range of 0.1-1.0 gallons/acre. In some embodiments, the rate of application of the liquid composition in a soil application may comprise a rate in the range of 1-2 gallons/acre. In some embodiments, the rate of application of the liquid composition in a soil application may comprise a rate in the range of 2-3 gallons/acre. In some embodiments, the rate of application of the liquid composition in a soil application may comprise a rate in the range of 3-4 gallons/acre. In some embodiments, the rate of application of the liquid composition in a soil application may comprise a rate in the range of 4-5 gallons/acre. In some embodiments, the rate of application of the liquid composition in a soil application may comprise a rate in the range of 5-10 gallons/acre.

Capillary Action Application

In another non-limiting embodiment, the administration of the liquid composition may comprise first soaking the seed in water, removing the seed from the water, drying the seed, applying an effective amount of the liquid composition below the seed planting level in the soil, and planting the seed, wherein the liquid composition supplied to the seed from below by capillary action. In some embodiments, the seed may be soaked in water for a time period in the range of 90-150 minutes. In some embodiments, the seed may be soaked in water for a time period in the range of 110-130 minutes. In some embodiments, the seed may be soaked in water for a time period in the range of 90-100 minutes. In some embodiments, the seed may be soaked in water for a time period in the range of 100-110 minutes. In some embodiments, the seed may be soaked in water for a time period in the range of 110-120 minutes. In some embodiments, the seed may be soaked in water for a time period in the range of 120-130 minutes. In some embodiments, the seed may be soaked in water for a time period in the range of 130-140 minutes. In some embodiments, the seed may be soaked in water for a time period in the range of 140-150 minutes.

The composition may be diluted to a lower concentration for an effective amount in a capillary action application by mixing a volume of the composition in a volume of water. The concentration of macroalgae sourced components resulting in the diluted composition may be calculated by the multiplying the original concentration in the composition by the ratio of the volume of the composition to the volume of water. Alternatively, the grams of macroalgae sourced components in the diluted composition can be calculated by the multiplying the original grams of macroalgae sourced components per 100 mL by the ratio of the volume of the composition to the volume of water.

Hydroponic Application

In another non-limiting embodiment, the administration of the liquid composition to a seed or plant may comprise applying the macroalgae based composition in combination with a nutrient medium to seeds disposed in and plants growing in a hydroponic growth medium or an inert growth medium (e.g., coconut husks). The liquid composition may be applied multiple times per day, per week, or per growing season.

Foliar Application

In one non-limiting embodiment, the administration of the composition may comprise contacting the foliage of the plant with an effective amount of the composition. In some embodiments, the liquid composition may be sprayed on the foliage by a hand sprayer, a sprayer on an agriculture implement, or a sprinkler.

The composition may be diluted to a lower concentration for an effective amount in a foliar application by mixing a volume of the composition in a volume of water. The concentration of macroalgae sourced components resulting in the diluted composition may be calculated by the multiplying the original concentration in the composition by the ratio of the volume of the composition to the volume of water. Alternatively, the grams of macroalgae sourced components in the diluted composition can be calculated by the multiplying the original grams of macroalgae sourced components per 100 mL by the ratio of the volume of the composition to the volume of water.

The rate of application of the composition at the desired concentration may be expressed as a volume per area. In some embodiments, the rate of application of the liquid composition in a foliar application may comprise a rate in the range of 10-50 gallons/acre. In some embodiments, the rate of application of the liquid composition in a foliar application may comprise a rate in the range of 10-15 gallons/acre. In some embodiments, the rate of application of the liquid composition in a foliar application may comprise a rate in the range of 15-20 gallons/acre. In some embodiments, the rate of application of the liquid composition in a foliar application may comprise a rate in the range of 20-25 gallons/acre. In some embodiments, the rate of application of the liquid composition in a foliar application may comprise a rate in the range of 25-30 gallons/acre. In some embodiments, the rate of application of the liquid composition in a foliar application may comprise a rate in the range of 30-35 gallons/acre. In some embodiments, the rate of application of the liquid composition in a foliar application may comprise a rate in the range of 35-40 gallons/acre. In some embodiments, the rate of application of the liquid composition in a foliar application may comprise a rate in the range of 40-45 gallons/acre. In some embodiments, the rate of application of the liquid composition in a foliar application may comprise a rate in the range of 45-50 gallons/acre.

In some embodiments, the rate of application of the liquid composition in a foliar application may comprise a rate in the range of 0.01-10 gallons/acre. In some embodiments, the rate of application of the liquid composition in a foliar application may comprise a rate in the range of 0.01-0.1 gallons/acre. In some embodiments, the rate of application of the liquid composition in a foliar application may comprise a rate in the range of 0.1-1.0 gallons/acre. In some embodiments, the rate of application of the liquid composition in a foliar application may comprise a rate in the range of 1-2 gallons/acre. In some embodiments, the rate of application of the liquid composition in a foliar application may comprise a rate in the range of 2-3 gallons/acre. In some embodiments, the rate of application of the liquid composition in a foliar application may comprise a rate in the range of 3-4 gallons/acre. In some embodiments, the rate of application of the liquid composition in a foliar application may comprise a rate in the range of 4-5 gallons/acre. In some embodiments, the rate of application of the liquid composition in a foliar application may comprise a rate in the range of 5-10 gallons/acre.

The frequency of the application of the composition may be expressed as the number of applications per period of time (e.g., two applications per month), or by the period of time between applications (e.g., one application every 21 days). In some embodiments, the plant may be contacted by the composition in a foliar application every 3-28 days. In some embodiments, the plant may be contacted by the composition in a foliar application every 4-10 days. In some embodiments, the plant may be contacted by the composition in a foliar application every 18-24 days. In some embodiments, the plant may be contacted by the composition in a foliar application every 3-7 days. In some embodiments, the plant may be contacted by the composition in a foliar application every 7-14 days. In some embodiments, the plant may be contacted by the composition in a foliar application every 14-21 days. In some embodiments, the plant may be contacted by the composition in a foliar application every 21-28 days.

Foliar application(s) of the composition generally begin after the plant has become established, but may begin before establishment, at defined time period after planting, or at a defined time period after emergence form the soil in some embodiments. In some embodiments, the plant may be first contacted by the composition in a foliar application 5-14 days after the plant emerges from the soil. In some embodiments, the plant may be first contacted by the composition in a foliar application 5-7 days after the plant emerges from the soil. In some embodiments, the plant may be first contacted by the composition in a foliar application 7-10 days after the plant emerges from the soil. In some embodiments, the plant may be first contacted by the composition in a foliar application 10-12 days after the plant emerges from the soil. In some embodiments, the plant may be first contacted by the composition in a foliar application 12-14 days after the plant emerges from the soil.

Soil Application—Plant

In another non-limiting embodiment, the administration of the composition may comprise contacting the soil in the immediate vicinity of the plant with an effective amount of the composition. In some embodiments, the liquid composition may be supplied to the soil by injection into to a low volume irrigation system, such as but not limited to a drip irrigation system supplying water beneath the soil through perforated conduits or at the soil level by fluid conduits hanging above the ground or protruding from the ground. In some embodiments, the liquid composition may be supplied to the soil by a soil drench method wherein the liquid composition is poured on the soil.

The composition may be diluted to a lower concentration for an effective amount in a soil application by mixing a volume of the composition in a volume of water. The concentration of macroalgae sourced components resulting in the diluted composition may be calculated by the multiplying the original concentration of macroalgae sourced components in the composition by the ratio of the volume of the composition to the volume of water. Alternatively, the grams of macroalgae cells in the diluted composition can be calculated by the multiplying the original grams of macroalgae sourced components per 100 mL by the ratio of the volume of the composition to the volume of water.

The rate of application of the composition at the desired concentration may be expressed as a volume per area. In some embodiments, the rate of application of the liquid composition in a soil application may comprise a rate in the range of 50-150 gallons/acre. In some embodiments, the rate of application of the liquid composition in a soil application may comprise a rate in the range of 75-125 gallons/acre. In some embodiments, the rate of application of the liquid composition in a soil application may comprise a rate in the range of 50-75 gallons/acre. In some embodiments, the rate of application of the liquid composition in a soil application may comprise a rate in the range of 75-100 gallons/acre. In some embodiments, the rate of application of the liquid composition in a soil application may comprise a rate in the range of 100-125 gallons/acre. In some embodiments, the rate of application of the liquid composition in a soil application may comprise a rate in the range of 125-150 gallons/acre.

In some embodiments, the rate of application of the liquid composition in a soil application may comprise a rate in the range of 10-50 gallons/acre. In some embodiments, the rate of application of the liquid composition in a soil application may comprise a rate in the range of 10-20 gallons/acre. In some embodiments, the rate of application of the liquid composition in a soil application may comprise a rate in the range of 20-30 gallons/acre. In some embodiments, the rate of application of the liquid composition in a soil application may comprise a rate in the range of 30-40 gallons/acre. In some embodiments, the rate of application of the liquid composition in a soil application may comprise a rate in the range of 40-50 gallons/acre.

In some embodiments, the rate of application of the liquid composition in a soil application may comprise a rate in the range of 0.01-10 gallons/acre. In some embodiments, the rate of application of the liquid composition in a soil application may comprise a rate in the range of 0.01-0.1 gallons/acre. In some embodiments, the rate of application of the liquid composition in a soil application may comprise a rate in the range of 0.1-1.0 gallons/acre. In some embodiments, the rate of application of the liquid composition in a soil application may comprise a rate in the range of 1-2 gallons/acre. In some embodiments, the rate of application of the liquid composition in a soil application may comprise a rate in the range of 2-3 gallons/acre. In some embodiments, the rate of application of the liquid composition in a soil application may comprise a rate in the range of 3-4 gallons/acre. In some embodiments, the rate of application of the liquid composition in a soil application may comprise a rate in the range of 4-5 gallons/acre. In some embodiments, the rate of application of the liquid composition in a soil application may comprise a rate in the range of 5-10 gallons/acre.

The frequency of the application of the composition may be expressed as the number of applications per period of time (e.g., two applications per month), or by the period of time between applications (e.g., one application every 21 days). In some embodiments, the plant may be contacted by the composition in a soil application every 3-28 days. In some embodiments, the plant may be contacted by the composition in a soil application every 4-10 days. In some embodiments, the plant may be contacted by the liquid composition in a soil application every 18-24 days. In some embodiments, the plant may be contacted by the composition in a soil application every 3-7 days. In some embodiments, the plant may be contacted by the composition in a soil application every 7-14 days. In some embodiments, the plant may be contacted by the composition in a soil application every 14-21 days. In some embodiments, the plant may be contacted by the composition in a soil application every 21-28 days.

Soil application(s) of the composition generally begin after the plant has become established, but may begin before establishment, at defined time period after planting, or at a defined time period after emergence form the soil in some embodiments. In some embodiments, the plant may be first contacted by the composition in a soil application 5-14 days after the plant emerges from the soil. In some embodiments, the plant may be first contacted by the composition in a soil application 5-7 days after the plant emerges from the soil. In some embodiments, the plant may be first contacted by the liquid composition in a soil application 7-10 days after the plant emerges from the soil. In some embodiments, the plant may be first contacted by the composition in a soil application 10-12 days after the plant emerges from the soil. In some embodiments, the plant may be first contacted by the composition in a soil application 12-14 days after the plant emerges from the soil.

Whether in a seed soak, soil, capillary action, foliar, or hydroponic application the method of use comprises relatively low concentrations of the composition. Even at such low concentrations, the described composition has been shown to be effective at producing an enhanced characteristic in plants. The ability to use low concentrations allows for a reduced impact on the environment that may result from over application and an increased efficiency in the method of use of the composition by requiring a small amount of material to produce the desired effect. In some embodiments, the use of the liquid composition with a low volume irrigation system in soil applications allows the low concentration of the liquid composition to remain effective and not be diluted to a point where the composition is no longer in at a concentration capable of producing the desired effect on the plants while also increasing the grower's water use efficiency.

In conjunction with the low concentrations of macroalgae extracts in the composition necessary to be effective for enhancing the described characteristics of plants, the composition may does not have be to administered continuously or at a high frequency (e.g., multiple times per day, daily). The ability of the composition to be effective at low concentrations and a low frequency of application was an unexpected result, due to the traditional thinking that as the concentration of active ingredients decreases the frequency of application should increase to provide adequate amounts of the active ingredients. Effectiveness at low concentration and application frequency increases the material usage efficiency of the method of using the composition while also increasing the yield efficiency of the agricultural process.

Administration of a dry composition treatment to the soil, seed, or plant can be in an amount effective to produce an enhanced characteristic in the plant compared to a substantially identical population of untreated plant. Such enhanced characteristics can comprise accelerated seed germination, accelerated seedling emergence, improved seedling emergence, improved leaf formation, accelerated leaf formation, improved plant maturation, accelerated plant maturation, increased plant yield, increased plant growth, increased plant quality, increased plant health, increased flowering, increased fruit yield, increased fruit growth, and increased fruit quality. Non-limiting examples of such enhanced characteristics can comprise accelerated achievement of the hypocotyl stage, accelerated protrusion of a stem from the soil, accelerated achievement of the cotyledon stage, accelerated leaf formation, increased leaf size, increased leaf area index, increased marketable plant weight, increased marketable plant yield, increased marketable fruit weight, increased production plant weight, increased production fruit weight, increased utilization (indicator of efficiency in the agricultural process based on ratio of marketable fruit to unmarketable fruit), increased chlorophyll content (indicator of plant health), increased plant weight (indicator of plant health), increased root weight (indicator of plant health), increased root mass (indicator of plant health), increased shoot weight (indicator of plant health), increased plant height, increased thatch height, increased resistance to salt stress, increased plant resistance to heat stress (temperature stress), increased plant resistance to heavy metal stress, increased plant resistance to drought, increased plant resistance to disease improved color, reduced insect damage, reduced blossom end rot, and reduced sun burn. Such enhanced characteristics can occur individually in a plant, or in combinations of multiple enhanced characteristics. The characteristic of flowering has is important for not only the ornamental market, but also for fruiting plants where an increase in flowering may correlate to an increase in fruit production.

Seed Coating

In one non-limiting embodiment, the administration of the macroalgae extracts composition treatment can comprise coating a seed. In some embodiments, a seed may be coated by passing through a slurry comprising macroalgae extracts and then dried. In some embodiments, the seed may be coated with the dried macroalgae based composition and other components such as, but not limited to, binders and fillers known in the art to be suitable for coating seeds. The fillers may comprise suitable inorganic particles such as, but not limited to, silicate particles, carbonate particles, and sulphate particles, quartz, zeolites, pumice, perlite, diatomaceous earth, pyrogene silica, Sb₂O₃, TiO₂, lithopone, ZnO, and hydrated aluminum oxide. The binders may include, but are not limited to, water-soluble polymers, polyvinyl acetate, polyvinyl alcohol, polyvinyl pyrrolidone, polyurethane, methyl cellulose, carboxymethyl cellulose, hydroxylpropyl cellulose, sodium alginate, polyacrylate, casein, gelatin, pullulan, polyacrylamide, polyethylene oxide, polystyrene, styrene acrylic copolymers, styrene butadiene polymers, poly (N-vinylacetamide), waxes, canauba wax, paraffin wax, polyethylene wax, bees wax, polypropylene wax, and ethylene vinyl acetate. In some embodiments, the seed coating may comprise a wetting and dispersing additive such as, but not limited to polyacrylates, organo-modified polyacrylates, sodium polyacrylates, polyurethanes, phosphoric acid esters, star polymers, and modified polyethers.

In some embodiments, the seed coating may comprise other components such as, but not limited to, a solvent, thickener, coloring agent, anti-foaming agent, biocide, surfactant, and pigment. In some embodiments, the seed coating may comprise a hydrogel or film coating materials. In some embodiments, the concentration of dried macroalgae components in the seed coating may comprise 0.001-20% solids. In some embodiments, the concentration of dried macroalgae components in the seed coating may comprise less than 0.1% solids. In some embodiments, the concentration of dried macroalgae components in the seed coating may comprise 0.001-0.01% solids. In some embodiments, the concentration of dried macroalgae components in the seed coating may comprise 0.01-0.1% solids. In some embodiments, the concentration of dried macroalgae components in the seed coating may comprise 0.1-1% solids. In some embodiments, the concentration of dried macroalgae components in the seed coating may comprise 1-2% solids. In some embodiments, the concentration of dried macroalgae components in the seed coating may comprise 2-3% solids. In some embodiments, the concentration of dried macroalgae components in the seed coating may comprise 3-5% solids. In some embodiments, the concentration of dried macroalgae components in the seed coating may comprise 5-10% solids. In some embodiments, the concentration of dried macroalgae components in the seed coating may comprise 10-15% solids. In some embodiments, the concentration of dried macroalgae components in the seed coating may comprise 15-20% solids. In some embodiments, the seed may be coated in a single step. In some embodiments, the seed may be coated in multiple steps. Conventional or otherwise suitable coating equipment or techniques may be used to coat the seeds. Suitable equipment may include drum coaters, fluidized beds, rotary coaters, side vended pan, tumble mixers, and spouted beds. Suitable techniques may comprise mixing in a container, tumbling, spraying, or immersion. After coating, the seeds may be dried or partially dried.

Soil Application

In another non-limiting embodiment, the administration of the dried macroalgae components composition treatment can comprise mixing an effective amount of the composition with a solid growth medium, such as soil, potting mix, compost, or inert hydroponic material, prior to planting a seed, seedling, or plant in the solid growth medium. The dried macroalgae components composition may be mixed in the solid growth medium at an inclusion level of 0.001-20% by volume. In some embodiments, the effective amount in a mixed solid growth medium application of the dried macroalgae components composition can comprise a concentration in the range of 0.001-0.01% solids. In some embodiments, the effective amount in a mixed solid growth medium application of the dried macroalgae components composition can comprise a concentration in the range of 0.01-0.1% solids. In some embodiments, the effective amount in a mixed solid growth medium application of the dried macroalgae components composition can comprise a concentration in the range of 0.1-1% solids. In some embodiments, the effective amount in a mixed solid growth medium application of the dried macroalgae components composition can comprise a concentration in the range of 1-3%% solids. In some embodiments, the effective amount in a mixed solid growth medium application of the dried macroalgae components composition can comprise a concentration in the range of 3-5% solids. In some embodiments, the effective amount in a mixed solid growth medium application of the dried macroalgae components composition can comprise a concentration in the range of 5-10% solids. In some embodiments, the effective amount in a mixed solid growth medium application of the dried macroalgae components composition can comprise a concentration in the range of 10-20% solids.

In another non-limiting embodiment, the administration of the dried macroalgae composition treatment can comprise inclusion in a solid growth medium during in-furrow plants or broadcast application to the ground. The dried microalgae composition may be applied at a rate of 50-500 grams/acre. In some embodiments, the application rate of the dried microalgae composition can comprise 50-100 grams/acre. In some embodiments, the application rate of the dried microalgae composition can comprise 100-150 grams/acre. In some embodiments, the application rate of the dried microalgae composition can comprise 150-200 grams/acre. In some embodiments, the application rate of the dried microalgae composition can comprise 200-250 grams/acre. In some embodiments, the application rate of the dried microalgae composition can comprise 250-300 grams/acre. In some embodiments, the application rate of the dried microalgae composition can comprise 300-350 grams/acre. In some embodiments, the application rate of the dried microalgae composition can comprise 350-400 grams/acre. In some embodiments, the application rate of the dried microalgae composition can comprise 400-450 grams/acre. In some embodiments, the application rate of the dried microalgae composition can comprise 450-500 grams/acre.

The dried macroalgae composition may be applied at a rate of 10-50 grams/acre. In some embodiments, the application rate of the dried macroalgae composition can comprise 10-20 grams/acre. In some embodiments, the application rate of the dried macroalgae composition can comprise 20-30 grams/acre. In some embodiments, the application rate of the dried macroalgae composition can comprise 30-40 grams/acre. In some embodiments, the application rate of the dried macroalgae composition can comprise 40-50 grams/acre.

The dried macroalgae composition may be applied at a rate of 0.001-10 grams/acre. In some embodiments, the application rate of the dried macroalgae composition can comprise 0.001-0.01 grams/acre. In some embodiments, the application rate of the dried macroalgae composition can comprise 0.01-0.1 grams/acre. In some embodiments, the application rate of the dried macroalgae composition can comprise 0.1-1.0 grams/acre. In some embodiments, the application rate of the dried macroalgae composition can comprise 1-2 grams/acre. In some embodiments, the application rate of the dried macroalgae composition can comprise 2-3 grams/acre. In some embodiments, the application rate of the dried macroalgae composition can comprise 3-4 grams/acre. In some embodiments, the application rate of the dried macroalgae composition can comprise 4-5 grams/acre. In some embodiments, the application rate of the dried macroalgae composition can comprise 5-10 grams/acre.

Promotion of Growth

The compositions of the invention can be applied to promote various aspects of crop performance, such as crop growth, which may be normal growth or growth under conditions of stress, such as salt stress, temperature stress (e.g., heat stress), dehydration stress, or other abiotic and/or biotic stress. In one exemplary aspect, a Gracilaria extract of the invention is used to promote the growth of roots of plant. Root growth promotion may be embodied in the increase of the number of roots, the increase in the size (length and/or weight) of roots, or a combination thereof. Examples of such growth promotion methods are disclosed in the experimental section (Examples) of this application. In one exemplary aspect, 1. A method of promoting growth of a plant subject to temperature stress comprising administering to the plant an amount of a Gracilaria extract that is effective to promote the growth of the temperature stressed plant. In one aspect, the treatment with a composition comprising 0.001% to 0.1% Gracilaria extract under temperature stress conditions resulted in an at least about 10% increase in plant biomass, such as an at least 15%, at least 20%, at least 25%, or more increase in biomass as compared to an untreated control. In some aspects, the composition of the invention is combined with one or more other agents that assist with plant health, reproduction, quality, or growth under such stress conditions, such as a microalgae, for example a microalgae derived from Aurantiochytrium.

Protection Against Diseases Such as White Mold (S. sclerotiorum)

In another non-limiting embodiment, the various inventive compositions of the invention are applied for the prevention or reduction of one or more biotic stress(ors) and/or one or more plant diseas(es), such as, for example, white mold (S. sclerotiorum). An effective amount of a Gracilaria extract composition can be administered to the plant in an effective manner, such as foliar administration in the case of white mold treatment or prevention. Treatment in this respect means reduction in the duration and/or extent of the incidence of disease. Compositions of the invention also or alternatively can be administered for the prevention (reduction of the severity, as measured by, e.g., lessening of the duration, amount of deleterious impact (e.g., measured terms of frequency of occurrence of death, size reduction, etc.), and/or extent (as measured by amount of impacted area in the applicable plants) of the infection/disease). In one embodiment, the administration of 0.001% to 0.01% of a Gracilaria extract (such as 0.005%-0.01%, 0.0075%-0.01%, 0.009-0.01%, 0.001%-0.008%, 0.001%-0.006%, 0.001%-0.005%, or 0.001%-0.003%) is effective to reduce the amount of S. sclerotiorum infection in a plant between about 15% to about 100%, such as at least about 20%, at least about 25%, at least about 30%, or at least about 35% (e.g., about 20%-100%, such as about 25% to about 95%, about 25% to about 90%, about 30% to about 80%, about 30% to about 75%, about 30% to about 70%, or about 35% to about 70%, such as about 40% to about 65%). Such percentage reductions can be applied to a particular plant or as an average reduction in a population of plants. In other particular aspects, the Gracilaria extract compositions of the invention are combined with one or additional products that treat, prevent, or otherwise modulate one or more diseases, such as white mold and/or white mold-associated conditions in the applicable plant(s) or plant population(s). In a particular aspect, the additional product is derived from microalgae, such as an Aurantiochytrium microalgae (such as an extract thereof, a fragment thereof such as a cell from which lipids or other components have been extracted, or a whole cell product). In another aspect, the additional product also or alternatively is an anti-fungal product, such as an amount of vinclozolin, benomyl, and/or thiophanate methyl, that alone or in combination with the Gracilaria extract is effective to treat, prevent, or otherwise modulate white mold infection/disease in the applicable plant or plant population. In another aspect, the composition is also or alternatively administered in association with an agent that prevents rotting such as an ozone treatment. Associated administration can mean co-administration or separate (serial) administration that is near enough in time to obtain the desired impact of administering the two or more agents in concert for the desired impact. The methods of the invention that are focused on the prevention of spread of disease such as white mold disease can advantageously be performed in areas that have been associated with recent infection, such as recent S. sclerotiorum infection, in areas that are associated with frequent infection as determined by longer term historical data or modeling, and/or in areas where S. sclerotiorum infection is predicted to occur through other means. Treatment methods can be performed where S. sclerotiorum is identified on plants or in a population of plants.

### EXAMPLES

Embodiments of the invention are exemplified and additional embodiments are disclosed in further detail in the following Examples, which are not in any way intended to limit the scope of any aspect of the invention described herein.

### Example 1—Fabaceae (Leguminosae)

Experiments are conducted to test effects of application of a Gracilaria based composition to crop plants of the family Fabaceae (Leguminosae). Application is done as in other examples herein, such that, in various treatments, (a) seeds are wetted or soaked in the composition; (b) seeds are coated in the composition; (c) the composition is mixed with a solid growth medium before planting the seeds; (d) the composition is applied to soil pre-germination; (e) the composition is applied to soil post-germination; (f) the composition is applied periodically to soil during the growing season; and/or (g) the composition is applied to leaves of the plants once or periodically during the growing season. Results are measures for appropriate plant characteristics including: seed germination rate, seed germination time, seedling emergence, seedling emergence time, seedling size, plan fresh weight, plant dry weight, utilization, fruit production, leaf production, leaf formation, leaf size, leaf area index, plant height, thatch height, plant health, plant resistance to salt stress, plant resistance to heat stress, plant resistance to heavy metal stress, plant resistance to drought, maturation time, yield, root length, root mass, color, insect damage, blossom end rot, softness, plant quality, fruit quality, flowering, and sun burn. Results show at least a 10% quantitative improvement and/or a statistically significant improvement as to at least one characteristic under at least one mode of application (a-g) of the composition.

### Example 2—Poaceae

Experiments are conducted to test effects of application of a Gracilaria based composition to crop plants of the family Poaceae. Application is done as in other examples herein, such that, in various treatments, (a) seeds are wetted or soaked in the composition; (b) seeds are coated in the composition; (c) the composition is mixed with a solid growth medium before planting the seeds; (d) the composition is applied to soil pre-germination; (e) the composition is applied to soil post-germination; (0 the composition is applied periodically to soil during the growing season; and/or (g) the composition is applied to leaves of the plants once or periodically during the growing season. Results are measures for appropriate plant characteristics including: seed germination rate, seed germination time, seedling emergence, seedling emergence time, seedling size, plan fresh weight, plant dry weight, utilization, fruit production, leaf production, leaf formation, leaf size, leaf area index, plant height, thatch height, plant health, plant resistance to salt stress, plant resistance to heat stress, plant resistance to heavy metal stress, plant resistance to drought, maturation time, yield, root length, root mass, color, insect damage, blossom end rot, softness, plant quality, fruit quality, flowering, and sun burn. Results show at least a 10% quantitative improvement and/or a statistically significant improvement as to at least one characteristic under at least one mode of application (a-g) of the composition.

### Example 3—Roasaceae

Experiments are conducted to test effects of application of a Gracilaria based composition to crop plants of the family Roasaceae. Application is done as in other examples herein, such that, in various treatments, (a) seeds are wetted or soaked in the composition; ((b) seeds are coated in the composition; (c) the composition is mixed with a solid growth medium before planting the seeds; (d) the composition is applied to soil pre-germination; (e) the composition is applied to soil post-germination; (f) the composition is applied periodically to soil during the growing season; and/or (g) the composition is applied to leaves of the plants once or periodically during the growing season. Results are measures for appropriate plant characteristics including: seed germination rate, seed germination time, seedling emergence, seedling emergence time, seedling size, plan fresh weight, plant dry weight, utilization, fruit production, leaf production, leaf formation, leaf size, leaf area index, plant height, thatch height, plant health, plant resistance to salt stress, plant resistance to heat stress, plant resistance to heavy metal stress, plant resistance to drought, maturation time, yield, root length, root mass, color, insect damage, blossom end rot, softness, plant quality, fruit quality, flowering, and sun burn. Results show at least a 10% quantitative improvement and/or a statistically significant improvement as to at least one characteristic under at least one mode of application (a-g) of the composition.

### Example 4—Vitaceae

Experiments are conducted to test effects of application of a Gracilaria based composition to crop plants of the family Vitaceae. Application is done as in other examples herein, such that, in various treatments, (a) seeds are wetted or soaked in the composition; (b) seeds are coated in the composition; (c) the composition is mixed with a solid growth medium before planting the seeds; (d) the composition is applied to soil pre-germination; (e) the composition is applied to soil post-germination; (0 the composition is applied periodically to soil during the growing season; and/or (g) the composition is applied to leaves of the plants once or periodically during the growing season. Results are measures for appropriate plant characteristics including: seed germination rate, seed germination time, seedling emergence, seedling emergence time, seedling size, plan fresh weight, plant dry weight, utilization, fruit production, leaf production, leaf formation, leaf size, leaf area index, plant height, thatch height, plant health, plant resistance to salt stress, plant resistance to heat stress, plant resistance to heavy metal stress, plant resistance to drought, maturation time, yield, root length, root mass, color, insect damage, blossom end rot, softness, plant quality, fruit quality, flowering, and sun burn. Results show at least a 10% quantitative improvement and/or a statistically significant improvement as to at least one characteristic under at least one mode of application (a-g) of the composition.

### Example 5—Brassicaeae (Cruciferae)

Experiments are conducted to test effects of application of a Gracilaria based composition to crop plants of the family Brassicaeae (Cruciferae). Application is done as in other examples herein, such that, in various treatments, (a) seeds are wetted or soaked in the composition; (b) seeds are coated in the composition; (c) the composition is mixed with a solid growth medium before planting the seeds; (d) the composition is applied to soil pre-germination; (e) the composition is applied to soil post-germination; (0 the composition is applied periodically to soil during the growing season; and/or (g) the composition is applied to leaves of the plants once or periodically during the growing season. Results are measures for appropriate plant characteristics including: seed germination rate, seed germination time, seedling emergence, seedling emergence time, seedling size, plan fresh weight, plant dry weight, utilization, fruit production, leaf production, leaf formation, leaf size, leaf area index, plant height, thatch height, plant health, plant resistance to salt stress, plant resistance to heat stress, plant resistance to heavy metal stress, plant resistance to drought, maturation time, yield, root length, root mass, color, insect damage, blossom end rot, softness, plant quality, fruit quality, flowering, and sun burn. Results show at least a 10% quantitative improvement and/or a statistically significant improvement as to at least one characteristic under at least one mode of application (a-g) of the composition.

### Example 6—Caricaceae

Experiments are conducted to test effects of application of a Gracilaria based composition to crop plants of the family Caricaceae. Application is done as in other examples herein, such that, in various treatments, (a) seeds are wetted or soaked in the composition; ((b) seeds are coated in the composition; (c) the composition is mixed with a solid growth medium before planting the seeds; (d) the composition is applied to soil pre-germination; (e) the composition is applied to soil post-germination; (0 the composition is applied periodically to soil during the growing season; and/or (g) the composition is applied to leaves of the plants once or periodically during the growing season. Results are measures for appropriate plant characteristics including: seed germination rate, seed germination time, seedling emergence, seedling emergence time, seedling size, plan fresh weight, plant dry weight, utilization, fruit production, leaf production, leaf formation, leaf size, leaf area index, plant height, thatch height, plant health, plant resistance to salt stress, plant resistance to heat stress, plant resistance to heavy metal stress, plant resistance to drought, maturation time, yield, root length, root mass, color, insect damage, blossom end rot, softness, plant quality, fruit quality, flowering, and sun burn. Results show at least a 10% quantitative improvement and/or a statistically significant improvement as to at least one characteristic under at least one mode of application (a-g) of the composition.

### Example 7—Malvaceae

Experiments are conducted to test effects of application of a Gracilaria based composition to crop plants of the family Malvaceae. Application is done as in other examples herein, such that, in various treatments, (a) seeds are wetted or soaked in the composition; (b) seeds are coated in the composition; (c) the composition is mixed with a solid growth medium before planting the seeds; (d) the composition is applied to soil pre-germination; (e) the composition is applied to soil post-germination; (0 the composition is applied periodically to soil during the growing season; and/or (g) the composition is applied to leaves of the plants once or periodically during the growing season. Results are measures for appropriate plant characteristics including: seed germination rate, seed germination time, seedling emergence, seedling emergence time, seedling size, plan fresh weight, plant dry weight, utilization, fruit production, leaf production, leaf formation, leaf size, leaf area index, plant height, thatch height, plant health, plant resistance to salt stress, plant resistance to heat stress, plant resistance to heavy metal stress, plant resistance to drought, maturation time, yield, root length, root mass, color, insect damage, blossom end rot, softness, plant quality, fruit quality, flowering, and sun burn. Results show at least a 10% quantitative improvement and/or a statistically significant improvement as to at least one characteristic under at least one mode of application (a-g) of the composition.

### Example 8—Sapindaceae

Experiments are conducted to test effects of application of a Gracilaria based composition to crop plants of the family Sapindaceae. Application is done as in other examples herein, such that, in various treatments, (a) seeds are wetted or soaked in the composition; (b) seeds are coated in the composition; (c) the composition is mixed with a solid growth medium before planting the seeds; (d) the composition is applied to soil pre-germination; (e) the composition is applied to soil post-germination; (f) the composition is applied periodically to soil during the growing season; and/or (g) the composition is applied to leaves of the plants once or periodically during the growing season. Results are measures for appropriate plant characteristics including: seed germination rate, seed germination time, seedling emergence, seedling emergence time, seedling size, plan fresh weight, plant dry weight, utilization, fruit production, leaf production, leaf formation, leaf size, leaf area index, plant height, thatch height, plant health, plant resistance to salt stress, plant resistance to heat stress, plant resistance to heavy metal stress, plant resistance to drought, maturation time, yield, root length, root mass, color, insect damage, blossom end rot, softness, plant quality, fruit quality, flowering, and sun burn. Results show at least a 10% quantitative improvement and/or a statistically significant improvement as to at least one characteristic under at least one mode of application (a-g) of the composition.

### Example 9—Anacardiaceae

Experiments are conducted to test effects of application of a Gracilaria based composition to crop plants of the family Anacardiaceae. Application is done as in other examples herein, such that, in various treatments, (a) seeds are wetted or soaked in the composition; (b) seeds are coated in the composition; (c) the composition is mixed with a solid growth medium before planting the seeds; (d) the composition is applied to soil pre-germination; (e) the composition is applied to soil post-germination; (0 the composition is applied periodically to soil during the growing season; and/or (g) the composition is applied to leaves of the plants once or periodically during the growing season. Results are measures for appropriate plant characteristics including: seed germination rate, seed germination time, seedling emergence, seedling emergence time, seedling size, plan fresh weight, plant dry weight, utilization, fruit production, leaf production, leaf formation, leaf size, leaf area index, plant height, thatch height, plant health, plant resistance to salt stress, plant resistance to heat stress, plant resistance to heavy metal stress, plant resistance to drought, maturation time, yield, root length, root mass, color, insect damage, blossom end rot, softness, plant quality, fruit quality, flowering, and sun burn. Results show at least a 10% quantitative improvement and/or a statistically significant improvement as to at least one characteristic under at least one mode of application (a-g) of the composition.

### Example 10—Growth of Treated Plants Under Normal and Salt Stress Conditions

An experiment was performed to determine the effect of treating Arabidopsis thaliana with an extract of Gracilaria gigas under normal growth conditions and under salt stressed conditions. The Gracilaria gigas biomass was subjected to an ethanol extraction process. The bioassay was initiated using four day old plantlets grown on half strength Murashige and Skoog (MS) medium, supplemented with 1% (w/v) sucrose and solidified with 0.4% (w/v) Phytagel in square petri plates. Plates were vertically stacked in the growth chamber set at 22° C. with 16-h light/8-h dark cycle, with light intensity of 100 μmol/m⁻² s⁻¹. Each plate contained five replicate plantlets. Plantlets were transferred on medium supplemented with concentrations of 0.01% (0.01 mL/L), 0.001% (0.001 mL/L), or 0.0001% (0.0001 mL/L) of an extract of Gracilaria gigas and compared to an untreated control. Each concentration of each treatment was tested in triplicate.

The Gracilaria treatments were prepared by first weighing out 100 grams of biomass. Next the biomass was heated at 95-90° C. for 1 hour with a solution of 30 g of NaOH (KOH is also suitable) in 1,000 mL of water. After the heating step, the reaction mixture was drained and the biomass was washed three times with water until free of the alkaline solution. The alkaline solution was then neutralized by the addition of sulfuric acid to a pH in the range of 6-8 and freeze dried to obtain the hydrolysis extract fraction. The filtered biomass was then soaked in 1 liter of a 0.01% hydrochloric acid solution for 10 minutes and washed three times with water. The washed biomass was then suspended in 700 mL of water and heated to reflux for 1 hour, blended, and then the paste and washing was heated for 3 hours at 95° C. The biomass was freeze dried and then extracted with ethanol to produce the extract treatment for application to plants. The ethanol extract process comprised, first mixing 600 grams of biomass with 3,000 mL of ethanol and heated at reflux for 2 hours. The reaction mixture was then filtered while hot and the biomass was extracted again with ethanol twice (2 times at 3,000 mL). The combined organic extracts from the process were concentrated to yield the extract treatment.

The salt stressed plantlets were also supplemented with 100 mM of NaCl. Seven days after the plantlets were treated plant dry weight, root length, amount of chlorotic leaves, and the amount of plants with chlorosis were measured. The results are shown in Tables 1-3, which display the results for each tested concentration with respect to the untreated control. For chlorosis metric, the reduction in the effect of chlorosis with respect to the control (i.e., improvement over the control) is represented as a negative (−) value.

TABLE 1
Growth (No Salt Stress)

| | Dry Weight % | Root Length % |
|---|---|---|
| Concentration | Difference vs. Control | Difference vs. Control |
| 0.01% | −25.7 | +23.1 |
| 0.001% | +4.8 | +28.1 |
| 0.0001% | −19.0 | +19.0 |

TABLE 2
Salt Stress

| | Dry Weight % | Root Length % |
|---|---|---|
| Concentration | Difference vs. Control | Difference vs. Control |
| 0.01% | −26.6 | +19.9 |
| 0.001% | +14.9 | +63.8 |
| 0.0001% | +35.6 | +72.8 |

TABLE 3
Chlorosis

| | Chlorotic leaves % | Plants with Chlorosis % |
|---|---|---|
| Concentration | Difference vs. Control | Difference vs. Control |
| 0.01% | +44.4 | +70.6 |
| 0.001% | +33.3 | +41.2 |
| 0.0001% | +33.3 | +52.9 |

As shown in Table 1, the 0.01% treatment showed an improvement in plant dry weight over the control in normal growth conditions. The 0.001% treatment showed the largest improvement in root length over the control in normal growth conditions, with the 0.01% and 0.0001% treatments also showing an improvement over the control. As shown in Table 2, the 0.0001% treatment showed the largest improvement in plant dry weight over the control in the salt stress conditions, with the 0.001% treatment also showing an improvement over the control. The 0.0001% showed the largest improvement in root length over the control in salt stress conditions, with the 0.01% and 0.001% treatments also showing an improvement over the control.

### Example 11—Second Growth Experiment Relating to Normal and Salt Stress Conditions

An experiment was performed to determine the effect of treating Arabidopsis thaliana with an extract of Gracilaria gigas under normal growth conditions and under salt stressed conditions. The Gracilaria gigas biomass was subjected to an ethanol extraction process. The bioassay was initiated using two week old Arabidopsis plants grown on Jiffy pellets (peat moss pellets). Five replicates of each plant were performed for the treatments. Plants on Jiffy pellets were placed on trays with concentrations of 0.01% (0.01 mL/L), 0.001% (0.001 mL/L), or 0.0001% (0.0001 mL/L) of an extract of Gracilaria gigas at 40 mL/plant and compared to an untreated control. The treatments were prepared as described in Example 10. The salt stressed plantlets were also supplemented with 150 mM of NaCl. Five days after the first treatment the extract of Gracilaria gigas treatment was repeated, but additional salt was not added. Ten days after the first treatment the plant dry weight was measured. The results are shown in Tables 4-5, which display the results for each tested concentration with respect to the untreated control.

TABLE 4
Growth (No Salt Stress)

| | Dry Weight % |
|---|---|
| Concentration | Difference vs. Control |
| 0.01% | +23.7 |
| 0.001% | +14.4 |
| 0.0001% | −7.2 |

TABLE 5
Salt Stress

| | Dry Weight % |
|---|---|
| Concentration | Difference vs. Control |
| 0.01% | −7.5 |
| 0.001% | −2.6 |
| 0.0001% | −9.1 |

As shown in Table 4, the 0.01% treatment showed the largest improvement in plant dry weight over the control in normal growth conditions, with the 0.001% treatment also showing an improvement over the control.

### Example 12—Growth of Treated Plants Under Normal and Temperature Stress Conditions

An experiment was performed to determine the effect of treating Arabidopsis thaliana with an extract of Gracilaria gigas under normal growth conditions and under temperature stressed conditions. The Gracilaria gigas biomass was subjected to an ethanol extraction process. The bioassay was initiated using four day old plantlets grown on half strength Murashige and Skoog (MS) medium, supplemented with 1% (w/v) sucrose and solidified with 0.7% (w/v) agar in square petri plates. Plates were vertically stacked in the growth chamber set at 22° C. with 16-h light/8-h dark cycle, with light intensity of 100 μmol/m⁻² s⁻¹. Each plate contained five replicate plantlets. Plantlets were transferred on medium supplemented with concentrations of 0.001% (0.001 mL/L) or 0.0001% (0.0001 mL/L) of an extract of Gracilaria gigas and compared to an untreated control. The treatments were prepared as described in Example 10. After seven days, half of the plates were placed in a growth chamber and subjected to three days of continuous temperature stress (35° C.) while the other half were maintained at about 22° C. Following the temperature stress period, the plantlets were allowed to grow for seven additional days, and plant dry weight was measured at the end. The results are shown in Tables 6-7, which display the results for each tested concentration with respect to the untreated control.

TABLE 6
Growth (No temperature Stress)

| | Dry Weight % |
|---|---|
| Concentration | Difference vs. Control |
| 0.001% | −4.3 |
| 0.0001% | −30.2 |

TABLE 7
Temperature Stress

| | Dry Weight % |
|---|---|
| Concentration | Difference vs. Control |
| 0.001% | +31.9 |
| 0.0001% | −9.1 |

As shown in Table 7, the 0.001% treatment showed an improvement in plant dry weight over the control in temperature stress conditions.

### Example 13—Root Growth Experiment 1

An experiment was performed to determine the effect of treating Phaseolus aureus (mung bean) with an extract of Gracilaria gigas under normal growth conditions. The Gracilaria gigas biomass was subjected to an ethanol extraction process. The biomass as initiated using cut mung bean seedlings which were grown in vials supplemented with concentrations of 0.01% (0.01 mL/L), 0.001% (0.001 mL/L), or 0.0001% (0.0001 mL/L) of an extract of Gracilaria gigas and compared to an untreated control. The mung bean seedlings were initially grown on vermiculite for two weeks and then cut approximately 3 cm below the cotyledons. Cut seedlings were placed in glass scintillation vials to which 15 mL of water or treatments were added. The treatments were prepared as described in Example 10. Five seedlings were used for each treatment. The root growth parameters of distance of root growth from meristem, number of roots, and root length were measured after 7 days. The results are shown in Table 8, which display the results for each tested concentration with respect to the untreated control.

TABLE 8

| | Distance of Root | | |
|---|---|---|---|
| | Growth from | Number of Roots % | Root Length % |
| | Meristem % | Difference vs. | Difference vs. |
| | Difference vs. Control | Control | Control |
| 0.01% | +3.7 | −34.6 | +1.5 |
| 0.001% | +44.4 | −21.5 | +41.5 |
| 0.0001% | +77.8 | +12.1 | +47.7 |

As shown in Table 8, the 0.0001% treatment showed the largest improvement in distance root growth from the meristem over the control, with the 0.01% and 0.001% treatments also showing an improvement. The 0.0001% treatment showed an improvement in number of roots over the control. All treatments showed an improvement in root length over the control, with the 0.0001% treatment showing the largest improvement.

### Example 14—Root Growth Experiment 2

The experiments described in Example 13 were repeated, once again using an extract of Gracilaria gigas obtained as described above in the mung bean root assay, with four replicates in each concentration of extract tested and ten replicates of control (water only). The results of this experiment are shown in Table 9. Unlike the first set of results, where larger roots were seen coupled with less total number of roots, in this second experiment a remarkable increase in root number was observed with roots of slightly smaller length than the control. The combination of the two sets of experimental results suggest that Gracilaria gigas extracts may be useful for promotion of root growth in terms of root size, number of roots, or both.

TABLE 9

| | | | Average of | | Average | |
|---|---|---|---|---|---|---|
| | Longest | | Maximum | | Number of | |
| | Root | | Root Length | | Roots (% | |
| | Length | Number of | (% of | | Difference | |
| Concentration | (mm) | Roots | Control) | | from Control) | |
| 0.01% | 31 | 48 | 25.2 | (97%) | 33.4 | (575.8%) |
| | 24 | 29 | | | | |
| | 23 | 32 | | | | |
| | 21 | 31 | | | | |
| 0.001% | 19 | 12 | 22.4 | (86%) | 14.2 | (244.8%) |
| | 31 | 8 | | | | |
| | 9 | 17 | | | | |
| | 27 | 22 | | | | |
| 0.0001% | 31 | 8 | 22.4 | (86%) | 14.2 | (244.8%) |
| | 22 | 14 | | | | |
| | 9 | 16 | | | | |
| | 27 | 12 | | | | |
| Control | 31 | 4 | 26 | (100%) | 5.8 | (NA) |
| | 25 | 7 | | | | |
| | 32 | 5 | | | | |
| | 26 | 4 | | | | |
| | 25 | 5 | | | | |
| | 31 | 7 | | | | |
| | 21 | 8 | | | | |
| | 17 | 7 | | | | |
| | 24 | 6 | | | | |
| | 28 | 5 | | | | |

### Example 15—Biotic Stress Assays

The effects of S. sclerotiorum on Arabidopsis thaliana Col-0 plants were assessed by determining disease severity. The experiment employed treatment with 2 ml of water/plant (control sample) or 2 ml of Gracilaria gigas extract prepared as described above (at a high concentration of 0.01% and low concentration of 0.001%). Foliar treatments were applied 24 h before the infection with S. sclerotiorum. Except where otherwise indicated, sixh plants were used for each treatment. For infection, S. sclerotiorum was grown on PDA medium for 3 days.

At the time of infection plants were around 21 days old. At this stage, all the plants had well developed leaves and they were infected by placing a plug with a diameter of 5 mm on the middle of the adaxial side of one leaf of each plant. Disease progression was initially observed for two days or in some cases 3 days, from 1 dpi (days post inoculation) to either just 2 dpi or 2 dpi and 3 dpi.

In an initial round of experiments, Gracilaria gigas extract, prepared via ethanol extraction as described above, at both 0.01% concentration and 0.001% concentration, resulted in zero (0%) detectable spread of S. sclerotiorum from the inserted plug in all of the experiments.

In a second round of experiments, spread of S. sclerotiorum in treated plants was observed for both 2 dpi and 3 dpi (with two infected leaf per plant), but at significantly reduced rates as compared to the control plants. The results of these experiments are shown in Table 10 (control results), Table 11 (0.001% extract treatment results), and Table 12 (0.01% extract treatment results) below.

TABLE 10
Biotic Stress Test (Control Plants)

| | | | 48 hrs | | | 72 hrs | | |
|---|---|---|---|---|---|---|---|---|
| | | | Horizontal | Vertical | | Horizontal | Vertical | |
| Tray | Plant | Leaf | reading (mm) | Reading (mm) | Average | reading (mm) | Reading (mm) | Average |
| 1 | 1 | 1 | 11.98 | 14.44 | 13.21 | Touching | | |
| | | | | | | Pellet | | |
| | | 2 | 8.26 | 6.31 | 7.285 | 37.66 | 10.18 | 23.92 |
| | 2 | 1 | 9.33 | 10.6 | 9.965 | Touching | | |
| | | | | | | Pellet | | |
| | | 2 | 11.19 | 18.62 | 14.905 | Touching | | |
| | | | | | | Pellet | | |
| | 3 | 1 | 15.28 | 16.13 | 15.705 | Touching | | |
| | | | | | | Pellet | | |
| | | 2 | 16.51 | 14.12 | 15.315 | Touching | | |
| | | | | | | Pellet | | |
| 2 | 1 | 1 | 14.14 | 33.9 | 24.02 | Touching | | |
| | | | | | | Pellet | | |
| | | 2 | 8.48 | 12.45 | 10.465 | 28.46 | 11.38 | 19.92 |
| | 2 | 1 | 13.96 | 15.85 | 14.905 | Touching | | |
| | | | | | | Pellet | | |
| | | 2 | 11.93 | 23.79 | 17.86 | Touching | | |
| | | | | | | Pellet | | |
| | 3 | 1 | 8.28 | 27.6 | 17.94 | Touching | | |
| | | | | | | Pellet | | |
| | | 2 | 0 | 0 | 0 | Touching | | |
| | | | | | | Pellet | | |

TABLE 11
Biotic Stress Test (0.001% Extract Treatment Results)

| | | | 48 hrs | | | 72 hrs | | |
|---|---|---|---|---|---|---|---|---|
| | | | Horizontal | Vertical | | Horizontal | Vertical | |
| Tray | Plant | Leaf | reading (mm) | Reading (mm) | Average | reading (mm) | Reading (mm) | Average |
| 1 | 1 | 1 | 15.17 | 11.57 | 13.37 | Touching | | |
| | | | | | | Pellet | | |
| | | 2 | 21.05 | 10.76 | 15.905 | 21.71 | 5.88 | 13.795 |
| | 2 | 1 | 26.37 | 15.96 | 21.165 | Touching | | |
| | | | | | | Pellet | | |
| | | 2 | 29.83 | 8.39 | 19.11 | Touching | | |
| | | | | | | Pellet | | |
| | 3 | 1 | 27.71 | 6.47 | 17.09 | 36.3 | 7.48 | 21.89 |
| | | 2 | 21.36 | 11.75 | 16.555 | Touching | | |
| | | | | | | Pellet | | |
| 2 | 1 | 1 | 7.04 | 5.02 | 6.03 | 16.03 | 10.61 | 13.32 |
| | | 2 | 0 | 0 | 0 | 11.71 | 11.12 | 11.415 |
| | 2 | 1 | 10.51 | 12.24 | 11.375 | Touching | | |
| | | | | | | Pellet | | |
| | | | | Average | 7.355833 | | Average | 8.39875 |

TABLE 12
Biotic Stress Test (0.01% Extract Treatment Results)

| | | | 48 hrs | | | 72 hrs | | |
|---|---|---|---|---|---|---|---|---|
| | | | Horizontal | Vertical | | Horizontal | Vertical | |
| Tray | Plant | Leaf | reading (mm) | Reading (mm) | Average | reading (mm) | Reading (mm) | Average |
| 1 | 1 | 1 | 25.38 | 4.28 | 14.83 | 19.57 | 10.73 | 15.15 |
| | | 2 | 2.91 | 5.27 | 4.09 | 4.18 | 5.18 | 4.68 |
| | 2 | 1 | 7.51 | 6.8 | 7.155 | 18.92 | 11.78 | 15.35 |
| | | 2 | 4.88 | 3.35 | 4.115 | 5.87 | 4.85 | 5.36 |
| | 3 | 1 | 32.89 | 15.23 | 24.06 | Touching | | |
| | | | | | | Pellet | | |
| | | 2 | 2.67 | 1.81 | 2.24 | 12.45 | 10.52 | 11.485 |
| 2 | 1 | 1 | 17.38 | 13.16 | 15.27 | Touching | | |
| | | | | | | Pellet | | |
| | | 2 | 20.98 | 11.48 | 16.23 | Touching | | |
| | | | | | | Pellet | | |
| | 2 | 1 | 9.14 | 10.13 | 9.635 | 26.77 | 13.09 | 19.93 |
| | | 2 | 0 | 0 | 0 | 5.26 | 5.59 | 5.425 |
| | 3 | 1 | 0 | 0 | 0 | 5.92 | 6.98 | 6.45 |
| | | 2 | 0 | 0 | 0 | 5.01 | 6.21 | 5.61 |
| | | | | Average | 8.135417 | | Average | 9.937778 |

Analyzing these results provides the following percentages of inhibition of infection (in terms of infected area) observed in the second round of experiments:

TABLE 13

| Time | Concentration | Percentage of Infection Inhibition |
|---|---|---|
| 48 H | 0.01% | 55% |
| | 0.001% | 60% |
| 72 H | 0.01% | 38% |
| | 0.001% | 45% |

### Aspects of the Invention

In one non-limiting embodiment, a method of plant enhancement may comprise administering to a plant, seedling, or seed a composition treatment comprising 0.0001-0.01% by weight of Gracilaria extract to enhance at least one plant characteristic. In some embodiments, the Gracilaria extract may be applied to a plant in at least one of salt stress and heat stress conditions.

In another non-limiting embodiment, a composition may comprise an extract of Gracilaria, in a concentration in the range of 0.0001-0.01% by weight.

In another non-limiting embodiment, a method of preparing a composition may comprise subjecting Gracilaria to an extraction process; separating the extracted aqueous and biomass fractions; and diluting the concentration of aqueous extract to a concentration in the range of 0.0001-0.01% by weight.

All references, including publications, patent applications, and patents, cited herein are hereby incorporated by reference in their entirety and to the same extent as if each reference were individually and specifically indicated to be incorporated by reference and were set forth in its entirety herein (to the maximum extent permitted by law), regardless of any separately provided incorporation of particular documents made elsewhere herein.

The use of the terms “a” and “an” and “the” and similar referents in the context of describing the invention are to be construed to cover both the singular and the plural, unless otherwise indicated herein or clearly contradicted by context.

Unless otherwise stated, all exact values provided herein are representative of corresponding approximate values (e.g., all exact exemplary values provided with respect to a particular factor or measurement can be considered to also provide a corresponding approximate measurement, modified by “about,” where appropriate). All provided ranges of values are intended to include the end points of the ranges, as well as values between the end points.

The description herein of any aspect or embodiment of the invention using terms such as “comprising”, “having,” “including,” or “containing” with reference to an element or elements is intended to provide support for a similar aspect or embodiment of the invention that “consists of”, “consists essentially of”, or “substantially comprises” that particular element or elements, unless otherwise stated or clearly contradicted by context (e.g., a composition described herein as comprising a particular element should be understood as also describing a composition consisting of that element, unless otherwise stated or clearly contradicted by context).

All headings and sub-headings are used herein for convenience only and should not be construed as limiting the invention in any way.

The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The citation and incorporation of patent documents herein is done for convenience only and does not reflect any view of the validity, patentability, and/or enforceability of such patent documents.

This invention includes all modifications and equivalents of the subject matter recited in the claims and/or aspects appended hereto as permitted by applicable law.

1. A method of reducing the severity of S. sclerotiorum infection comprising administering to a plant an amount of a Gracilaria extract that is effective to reduce the area of visible S. sclerotiorum infection in the plant by at least 30%.

2. The method of claim 1, wherein the amount of Gracilaria extract is capable of reducing the area of visible S. sclerotiorum infection in a population of plants by an average of at least 50%.

3. The method of claim 1 or claim 2, wherein the extract is obtained from Gracilaria gigas.

4. The method of any one of claims 1-3, wherein the concentration of Gracilaria extract administered to the plant is between 0.001% and 0.01%.

5. The method of any one of claims 1-4, wherein the plant is in an area that is associated with one or more recent S. sclerotiorum infections, frequent S. sclerotiorum infection, or a combination thereof.

6. The method of any one of claims 1-5, wherein the Gracilaria extract is administered in association with a second agent that is known to detectably reduce the incidence of S. sclerotiorum infection in the plant, the severity of S. sclerotiorum infection in the plant, or a combination thereof.

7. The method of claim 6, wherein the second agent comprises an Aurantiochytrium microalgae cell or a fragment thereof.

8. A composition for enhancing at least one plant characteristic, the composition comprising an extract of Gracilaria in a concentration in the range of 0.0001-0.01% by weight, wherein the plant characteristic is one of increased plant growth, increased root growth, increased plant resistance to salt stress, increased plant resistance to heat stress, and increased plant resistance to S. sclerotiorum infection.

9. The composition of claim 8 further comprising microalgae cells or fragments thereof, wherein the microalgae cells are one of Chlorella cells and Aurantiochytrium cells.

10. A method of enhancing at least one plant characteristic comprising administering to a plant an amount of a Gracilaria extract in a concentration in the range of 0.0001-0.01% by weight, wherein the plant characteristic is one of increased plant growth, increased root growth, increased plant resistance to salt stress, increased plant resistance to heat stress, and increased plant resistance to S. sclerotiorum infection.

11. The method of claim 10 further comprising administering to the plant an amount of the Gracilaria extract that is effective to reduce the area of visible S. sclerotiorum infection in the plant by at least 30%.
